(19) United States
(12) Patent Application Publication
(10) Pub. No.: US 2026/0100343 A1
(43) Pub. Date: Apr. 9, 2026

(54) CHARGE FILTER ARRANGEMENT AND APPLICATIONS THEREOF

(71) Applicant: THE TRUSTEES OF INDIANA UNIVERSITY, Bloomington, IN (US)

(72) Inventors: Martin F. JARROLD, Bloomington, IN (US); David E. CLEMMER, Bloomington, IN (US)

(21) Appl. No.: 19/414,824

(22) Filed: Dec. 10, 2025

Related U.S. Application Data
(63) Continuation of application No. 17/781,485, filed on Jun. 1, 2022.
(60) Provisional application No. 62/949,555, filed on Dec. 18, 2019.

(51) Int. Cl. H01J 49/42; H01J 49/06

(52) U.S. Cl. CPC H01J 49/4215; H01J 49/061

(57) ABSTRACT

A charge filter instrument includes a field-free drift region, a plurality of charge detection cylinders in the drift region through which ions drifting axially therethrough pass, a plurality of charge sensitive amplifiers each coupled to at least one of the charge detection cylinders and configured to produce a charge detection signal corresponding to a charge of one or multiple ions simultaneously passing therethrough, a charge deflector or charge steering device coupled to the outlet end of the drift region, means for determining charge magnitudes or charge states of each of the ions drifting axially through the drift region based on the charge detection signals, and means for controlling the charge deflector or the charge steering device to pass through at least one outlet thereof only ions having a determined charge magnitude or charge state equal to, or within a specified range of, a specified charge magnitude or charge state.

### CROSS-REFERENCE TO RELATED APPLICATION

This application is a continuation of U.S. Application Ser. No. 17/781,485, filed June 1, 2022, which is a U.S. national stage entry of PCT Application No. PCT/US2020/065300, filed December 16, 2020, which claims the benefit of and priority to U.S. Provisional Patent Application Ser. No. 62/949,555, filed December 18, 2019, the disclosures of which are incorporated herein by reference in their entireties.

### TECHNICAL FIELD

The present disclosure relates generally to instruments configured to measure particle charges and selectively filter such particles based on their charge, and further to particle measurement devices or systems in which such instruments may be implemented.

### BACKGROUND

Spectrometry instruments provide for the identification of chemical components of a substance by measuring one or more molecular characteristics of the substance. Some such instruments are configured to analyze the substance in solution and others are configured to analyze charged particles of the substance in a gas phase. Molecular information produced by many such charged particle measuring instruments is limited because such instruments lack the ability to measure particle charge or to process particles based on their charge.

### SUMMARY

The present disclosure may comprise one or more of the features recited in the attached claims, and/or one or more of the following features and combinations thereof. In one aspect, a charge filter instrument may comprise an electric field-free drift region having an inlet end and an outlet end opposite the inlet end, the inlet end configured to be coupled to an ion source to receive ions to drift axially through the drift region from the inlet end toward the outlet end, a plurality of spaced-apart charge detection cylinders disposed in the drift region and through which ions drifting axially through the drift region pass, a plurality of charge sensitive amplifiers each coupled to a at least one of the plurality of charge detection cylinders and each configured to produce a charge detection signal corresponding to a magnitude of charge of one or more of ions passing through a respective at least one of the plurality of charge detection cylinders, one of a charge deflector, having a single inlet and a single outlet, and a charge steering device, having a single inlet and multiple outlets, coupled to the outlet end of the drift region, means for determining charge magnitudes or charge states of ions drifting axially through the drift region based on the charge detection signals produced by at least some of the plurality of charge sensitive amplifiers, and means for controlling the one of the charge deflector and the charge steering device to pass through a corresponding one of the single outlet and a specified one of the multiple outlets only ions having a specified charge magnitude or charge state.

In another aspect, an ion filter instrument may comprise an electric field-free drift region having an inlet end and an outlet end opposite the inlet end, the inlet end configured to be coupled to an ion source to receive ions to drift axially through the drift region from the inlet end toward the outlet end, a plurality of spaced-apart charge detection cylinders disposed in the drift region and through which ions drifting axially through the drift region pass, a plurality of charge sensitive amplifiers each coupled to at least one of the plurality of charge detection cylinders and each configured to produce a charge detection signal corresponding to a magnitude of charge of one or more of ions passing through a respective at least one of the plurality of charge detection cylinders, one of a charge deflector, having a single inlet and a single outlet, and a charge steering device, having a single inlet and multiple outlets, coupled to the outlet end of the drift region, at least one voltage source having at least one voltage output operatively coupled to the one of the charge deflector and the charge steering device, at least one processor, and at least one memory having instructions stored therein executable by the at least one processor to cause the at least one processor to (a) monitor the charge detection signals produced by at least some of the plurality of charge sensitive amplifiers as ions drift axially through the field-free drift region toward the outlet end thereof, (b) determine charge magnitudes or charge states of ions drifting axially through the field-free drift region based on the monitored charge detection signals, and (c) control the at least one voltage output of the at least one voltage source to cause the one of the charge deflector and the charge steering device to pass through a corresponding one of the single outlet and a specified one of the multiple outlets only ions having a specified charge magnitude or charge state.

### BRIEF DESCRIPTION OF THE DRAWINGS

FIG. 1 is a simplified diagram of a charge filter arrangement configured to filter ions as a function of ion charge by selectively passing ions having a specified charge or by selectively steering ions having different specified charges along different respective ion travel paths.

FIG. 2A is a simplified diagram of a portion of an illustrative example of the charge filter arrangement of FIG. 1 which includes 3 charge detection cylinders axially arranged in the field-free drift region, and illustrating an example charged particle P entering the first charge detection cylinder at a time T1 and exiting the first charge detection cylinder at a time T2 > T1.

FIG. 2B is a simplified diagram similar to FIG. 2A and illustrating the example charged particle P entering the second charge detection cylinder at a time T3 > T2 and exiting the second charge detection cylinder at a time T4 > T3.

FIG. 2C is a simplified diagram similar to FIGS. 2A and 2B, and illustrating the example charged particle P entering the third charge detection cylinder at a time T5 > T4 and exiting the third charge detection cylinder at a time T6 > T5.

FIG. 2D is a simplified diagram similar to FIGS. 2A-2C and illustrating the example charged particle P entering the charge deflection or charge steering region of the charge filter arrangement at a time T7 > T6.

FIG. 3 is a plot of charge magnitude vs. time illustrating example outputs of the charge sensitive amplifiers CA1-CA3 as the example charged particle P passes through the respective first, second and third charge detection cylinders as depicted in FIGS. 2A-2D

FIG. 4A is a simplified diagram of the example charge filter arrangement depicted in FIGS. 2A-2D, illustrating two example charged particles P1 and P2 of slightly different mass-to-charge ratios moving along the field-free drift region with one of the charged particles P1 shown entering the first charge detection cylinder at a time T1 and the other charged particle P2 lagging behind P1.

FIG. 4B is a simplified diagram similar to FIG. 4A illustrating respective positions of the two example charged particles P1 and P2 in the field-free drift region at a time T2 > T1.

FIG. 4C is a simplified diagram similar to FIGS. 4A and 4B illustrating respective positions of the two example charged particles P1 and P2 in the field-free drift region at a time T3 > T2.

FIG. 4D is a simplified diagram similar to FIGS. 4A-4C illustrating respective positions of the two example charged particles P1 and P2 in the field-free drift region at a time T4 > T3.

FIG. 4E is a simplified diagram similar to FIGS. 4A-4D illustrating respective positions of the two example charged particles P1 and P2 in the field-free drift region at a time T5 > T4.

FIG. 4F is a simplified diagram similar to FIGS. 4A-4E illustrating respective positions of the two example charged particles P1 and P2 in the field-free drift region at a time T6 > T5.

FIG. 4G is a simplified diagram similar to FIGS. 4A-4F illustrating respective positions of the two example charged particles P1 and P2 in the field-free drift region at a time T7 > T6.

FIG. 4H is a simplified diagram similar to FIGS. 4A-4G illustrating respective positions of the two example charged particles P1 and P2 in the field-free drift region at a time T8 > T7.

FIG. 4I is a simplified diagram similar to FIGS. 4A-4H illustrating respective positions of the two example charged particles P1 and P2 in the field-free drift region at a time T9 > T8.

FIG. 4J is a simplified diagram similar to FIGS. 4A-4I illustrating respective positions of the two example charged particles P1 and P2 in the field-free drift region at a time T10 > T9.

FIG. 4K is a simplified diagram similar to FIGS. 4A-4J illustrating respective positions of the two example charged particles P1 and P2 in the field-free drift region at a time T11 > T10.

FIG. 4L is a simplified diagram similar to FIGS. 4A-4K illustrating the position of the charged particle P2 in the field-free drift region and showing the charged particle P1 entering the charge deflection or steering region of the charge filter arrangement at a time T12 > T11.

FIG. 4M is a simplified diagram similar to FIGS. 4A-4L illustrating the position of the charged particle P2 in the field-free drift region at a time T13 > T12.

FIG. 4N is a simplified diagram similar to FIGS. 4A-4M showing the charged particle P2 entering the charge deflection or steering region of the charge filter arrangement at a time T14 > T13.

FIG. 5 is a plot of charge magnitude vs. time illustrating an example output of the charge sensitive amplifier CA1 as the two example charged particles P1 and P2 pass through the first charge detection cylinder during the time window T1 – T5 as depicted in FIGS. 4A-4E.

FIG. 6 is a plot of charge magnitude vs. time illustrating an example output of the charge sensitive amplifier CA2 as the two example charged particles P1 and P2 pass through the second charge detection cylinder during the time window T4 – T9 as depicted in FIGS. 4D-4I.

FIG. 7 is a plot of charge magnitude vs. time illustrating an example output of the charge sensitive amplifier CA3 as the two example charged particles P1 and P2 pass through the third charge detection cylinder during the time window T8 – T13 as depicted in FIGS. 4H-4M.

FIG. 8 is a simplified diagram of the charge deflection or steering region of the charge filter arrangement of FIG. 1 illustrated in the form of an embodiment of a controllable charge deflector.

FIG. 9A is a simplified diagram of the charge deflection or steering region of the charge filter arrangement of FIG. 1 illustrated in the form of another embodiment of a controllable charge deflector.

FIG. 9B is a cross-sectional view of the charge deflector of FIG. 9A as viewed along section lines 9B-9B.

FIG. 10A is a simplified diagram of the charge deflection or steering region of the charge filter arrangement of FIG. 1 illustrated in the form of an embodiment of a controllable single inlet, multiple outlet charge steering structure.

FIG. 10B is a cross-sectional view of the charge steering structure of FIG. 10A as viewed along section lines 10B-10B.

FIG. 11 is a simplified diagram of the charge deflection or steering region of the charge filter arrangement of FIG. 1 illustrated in the form of another embodiment of a controllable single inlet, multiple outlet charge steering device.

FIG. 12 is a simplified diagram of an embodiment of a particle measurement instrument including the charge filter arrangement of FIG. 1, with the charge deflection or steering region implemented in the form of a charge deflector, interposed between an ion source region and an ion measurement stage.

FIG. 13 is a simplified diagram of another embodiment of a particle measurement instrument including the charge filter arrangement of FIG. 1, with the charge deflection or steering region implemented in the form of a single inlet, multiple outlet charge steering device, interposed between an ion source region and each of multiple ion measurement stages.

FIG. 14 is a simplified diagram of yet another embodiment of a particle measurement instrument including the charge filter arrangement of FIG. 1, with the charge deflection or steering region implemented in the form of an ion steering structure including multiple single inlet, multiple outlet ion steering devices, interposed between an ion source region and a single ion measurement stage.

FIG. 15 is a simplified diagram of an embodiment of an ion source region that may be implemented with any of the charged particle measurement instruments of FIGS. 12-14.

FIG. 16 is a simplified diagram of an embodiment of an ion measurement stage that may be implemented with any of the charge particle measurement instruments of FIGS. 12-14.

FIG. 17 is a simplified diagram of still another embodiment of a particle measurement instrument including two cascaded implementations of the charge filter arrangements of FIG. 1 with an ion processing region positioned therebetween, and with the combined charged filter arrangements interposed between an ion source region and an ion measurement stage.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

This disclosure relates to apparatuses and techniques for determining charges or charge states of charged particles moving through a drift region, and for filtering the charged particles as a function of charge value or charge state by selectively passing those of the charged particles having a specified charge value or charge state, or by selectively steering charged particles having different specified charge values or charge states along different respective travel paths. For purposes of this document, the terms “charged particle” and “ion” may be used interchangeably, and both terms are intended to refer to any particle having a net positive or negative charge.

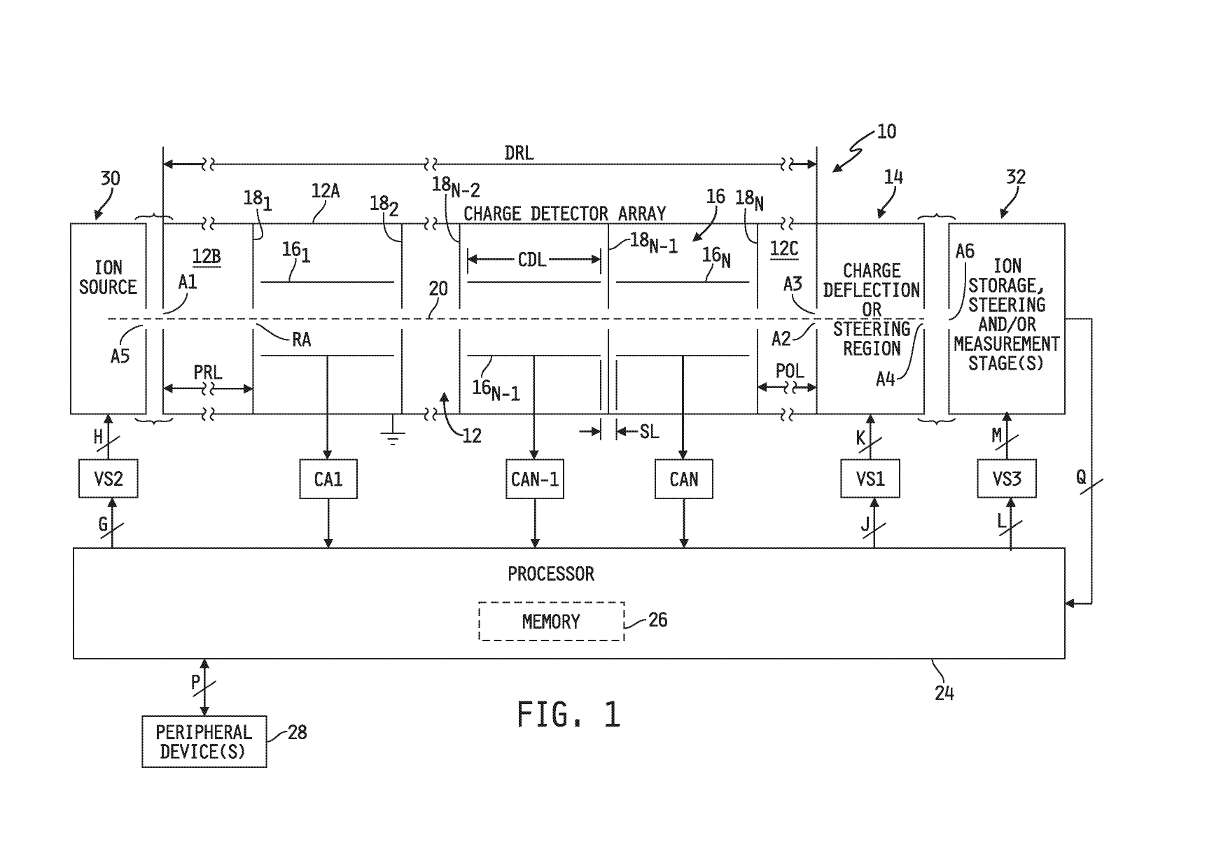

Referring now to FIG. 1, a diagram is shown of a charge filter instrument 10 configured to filter ions as a function of ion charge by selectively passing ions having a specified charge or by selectively steering ions having different specified charges along different respective ion travel paths. In the illustrated embodiment, the charge filter instrument 10 includes a drift region 12 having an ion inlet A1 at one end thereof and an ion outlet A2 at an opposite end thereof. In the embodiment depicted in FIG. 1, the drift region 12 is a linear drift region defined within an elongated drift tube 12A. The drift region 12 has a length DRL between the inlet A1 and the outlet A2, and a longitudinal axis 20 extends centrally through the drift region 12 and centrally through each of the inlet and outlet A1, A2 respectively. It will be understood that whereas the drift region 12 is illustrated in FIG. 1 in the form of a linear drift region, the drift region 12 may, in alternate embodiments, be non-linear in whole or in part. As one non-limiting example, the drift region 12 may be provided in the form of a circular drift region including conventional ion inlet (i.e., entrance) and ion outlet (i.e., exit) structures. Other examples of at least partially non-linear drift regions will occur to those skilled in the art, and it will be understood that any such alternate configurations are intended to fall within the scope of this disclosure.

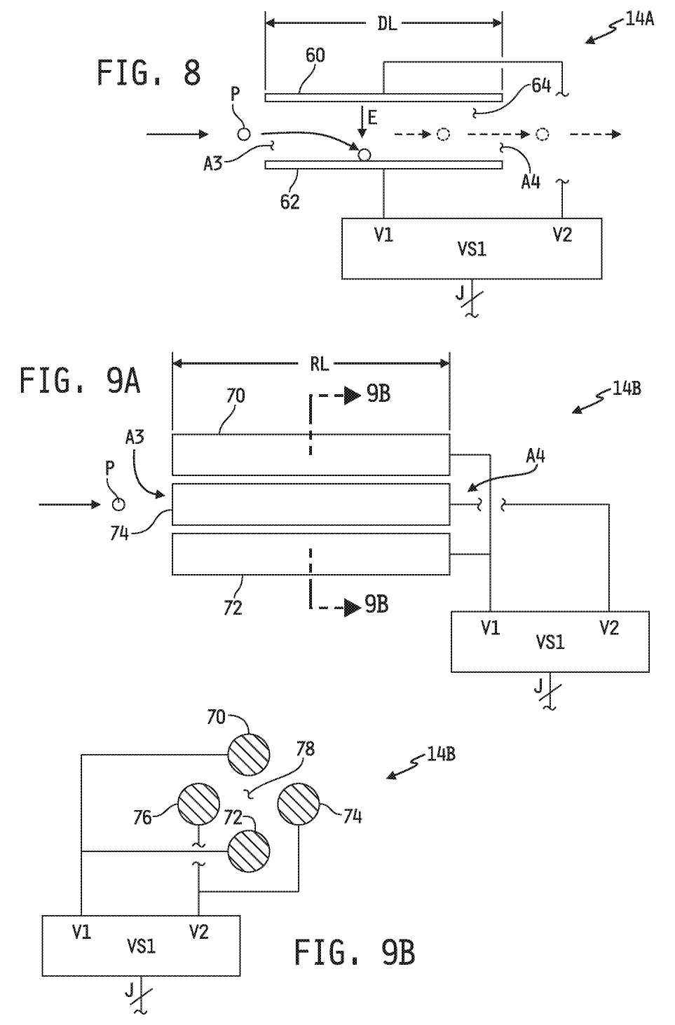

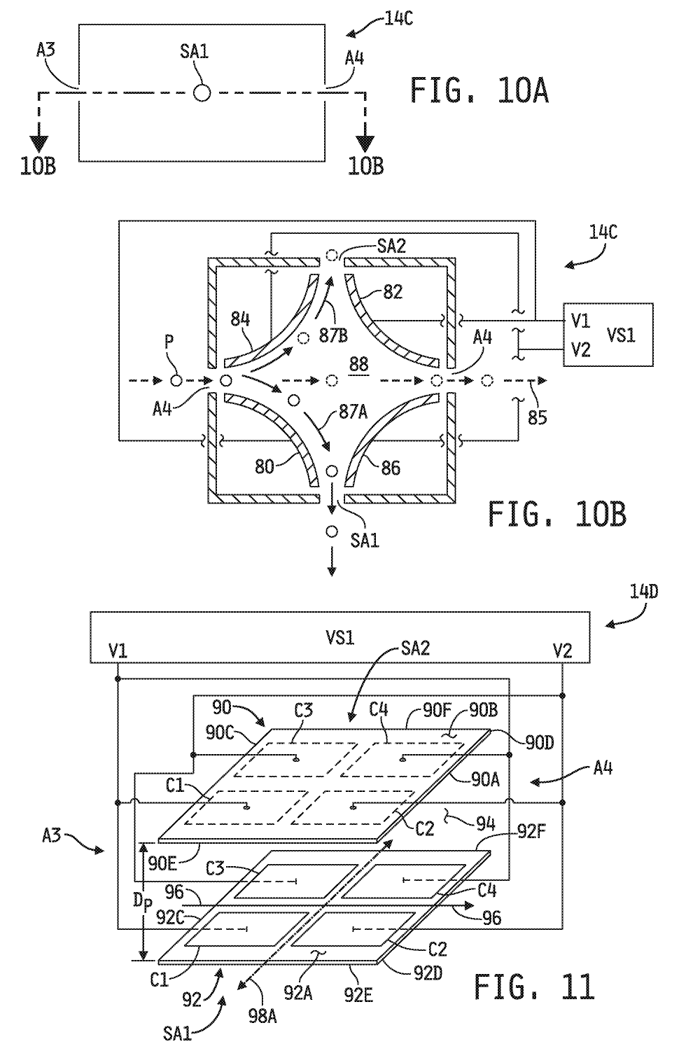

A charge deflection or steering region 14 is coupled to or otherwise positioned at the outlet end of the drift region 12. In the illustrated embodiment, the charge deflection or steering region 14 has an ion inlet A3 defined by or positioned adjacent to the ion outlet A2 of the drift region 12, and an ion outlet A4. In some embodiments, the charge deflection or steering region 14 may be implemented in the form of a charge deflector controllable to selectively pass or prevent passage ions therethrough, some non-limiting example embodiments of which are illustrated in FIGS. 8-9B and will be described in detail below. In other embodiments, the charge deflection or steering region 14 may be implemented in the form of one or more single inlet, multiple outlet charge steering instruments or structures each controllable to selectively steer ions entering the single inlet through one or more of the multiple outlets, some non-limiting example embodiments of which are illustrated in FIGS. 10A-11 and will be described in detail below.

A voltage source VS1 is electrically connected to the charge deflection or steering region 14 via a number, K, of signal paths, where K may be any positive integer. In some embodiments, the voltage source VS1 may be implemented in the form of a single voltage source, and in other embodiments the voltage source VS1 may include any number of separate voltage sources. In some embodiments, the voltage source VS1 may be configured or controlled to produce and supply one or more time-invariant (i.e., DC) voltages of selectable magnitude. Alternatively or additionally, the voltage source VS1 may be configured or controlled to produce and supply one or more switchable time-invariant voltages, i.e., one or more switchable DC voltages. Alternatively or additionally, the voltage source VS1 may be configured or controllable to produce and supply one or more time-varying signals of selectable shape, duty cycle, peak magnitude and/or frequency. As one specific example of the latter embodiment, which should not be considered to be limiting in any way, the voltage source VS1 may be configured or controllable to produce and supply one or more time-varying voltages in the form of one or more sinusoidal (or other shaped) voltages.

The voltage source VS1 is illustratively shown electrically connected by a number, J, of signal paths to a conventional processor 24, where J may be any positive integer. The processor 24 is illustratively conventional and may include a single processing circuit or multiple processing circuits. The processor 24 illustratively includes or is coupled to a memory 26 having instructions stored therein which, when executed by the processor 24, cause the processor 24 to control the voltage source VS1 to produce one or more output voltages for selectively controlling operation of the charge deflection or steering region 14. In some embodiments, the processor 24 may be implemented in the form of one or more conventional microprocessors or controllers, and in such embodiments the memory 26 may be implemented in the form of one or more conventional memory units having stored therein the instructions in a form of one or more microprocessor-executable instructions or instruction sets. In other embodiments, the processor 24 may be alternatively or additionally implemented in the form of a field programmable gate array (FPGA) or similar circuitry, and in such embodiments the memory 26 may be implemented in the form of programmable logic blocks contained in and/or outside of the FPGA within which the instructions may be programmed and stored. In still other embodiments, the processor 24 and/or memory 26 may be implemented in the form of one or more application specific integrated circuits (ASICs). Those skilled in the art will recognize other forms in which the processor 24 and/or the memory 26 may be implemented, and it will be understood that any such other forms of implementation are contemplated by, and are intended to fall within, this disclosure. In some alternative embodiments, the voltage source VS1 may itself be programmable to selectively produce one or more constant and/or time-varying output voltages.

A charge detector array 16 is illustratively disposed within, or integral with, the drift region 12. In the embodiment illustrated in FIG. 1, the charge detector array 16 illustratively includes a plurality, N, of spaced-apart, cascaded charge detection cylinders 16₁ – 16_{N}, where N may be any positive integer greater than 2. In one example embodiment, which should not be considered limiting in any way, N may be approximately 100, although in other embodiments N may be less than 100 or greater than 100. In any case, the charge detection cylinders 16₁ – 16_{N} each define a bore therethrough so as to allow ions to pass through the respective cylinder, and in the illustrated embodiment the charge detection cylinders 16₁ – 16_{N} are arranged end-to-end so that the central, longitudinal axis 20 of the drift region 12 passes centrally through each. In the illustrated embodiment, each charge detection cylinder 16₁ – 16_{N} defines a length CDL between ion inlet and ion outlet ends thereof, although in alternate embodiments one or more of the charge detection cylinders 16₁ – 16_{N} may have a length that is greater or less than the length CDL. The minimum CDL is illustratively that which is physically realizable and which will produce an electrically detectable signal response to one or more ions passing therethrough. Although no upper limit on CDL exists in theory, practical considerations, such as available space and instrument operating conditions, will typically limit the maximum useful CDL in any particular application.

In the illustrated embodiment, each of a plurality of ground rings 18₂ – 18_{N-1} is positioned within the space defined between each adjacent pair of charge detection cylinders 16₁ – 16_{N}, another ground ring 18₁ is positioned adjacent to the ion inlet of the first charge detection cylinder 16₁ and yet another ground ring 18_{N} is positioned adjacent to the ion outlet of the last charge detection cylinder 16_{N}. Each ground ring 18₁ – 18_{N} illustratively defines a ring aperture RA therethrough and through which the longitudinal axis 20 centrally passes, where RA is illustratively less than or equal to the inner diameters of the charge detection cylinders 16₁ – 16_{N}. In the illustrated embodiment, the charge detection cylinders 16₁ – 16_{N} are axially spaced apart from one another by a space length SL. In the illustrated embodiment, each of the ground rings 18₁ – 18_{N} is positioned such that the distances between the ion inlets of the charge detection cylinders 16₁ – 16_{N} and respective ones of the ground rings 18₁ – 18_{N-1} are substantially equal to one another, the distances between the ion outlets of the charge detection cylinders 16₁ – 16_{N} and respective ones of the ground rings 18₂ – 18_{N} are substantially equal to one another, and the distances between the ion inlets of the charge detection cylinders 16₁ – 16_{N} and respective ones of the ground rings 18₁ – 18_{N-1} are substantially equal to the distances between the ion outlets of the charge detection cylinders 16₁ – 16_{N} and respective ones of the ground rings 18₂ – 18_{N}. In some embodiments, one or more of the ground rings 18₁ – 18_{N} may be omitted.

In one example embodiment, the drift tube 12A is provided in the form of an electrically conductive cylinder which is illustratively coupled to ground potential (as depicted in FIG. 1) or to another reference potential, and within which the plurality of charge detection cylinders 16₁ – 16_{N} are suitably mounted. In such embodiments which include one or more ground rings 18₁ – 18_{N,} such one or more ground rings may be electrically and mechanically coupled to an inner surface of the electrically conductive cylinder, or may be formed integral with the electrically conductive cylinder such that the electrically conductive cylinder and the one or more ground rings 18₁ – 18_{N} are of unitary construction. In another example embodiment, the drift tube 12A may be formed of an interconnected series of alternating electrically conductive or electrically insulating spacers and respective ones of the plurality of ground rings 18₁ – 18_{N}, within which the plurality of charge detection cylinders 16₁ – 16_{N} may be suitably mounted. In still another example embodiment, the drift tube 12A may be provided in the form of a sheet of flexible or semi-flexible, electrically insulating material, e.g., a flexible circuit board, to which a plurality of spaced-apart, parallel, electrically conductive strips are attached or upon which a plurality of spaced-apart, parallel, electrically conductive strips are formed in a conventional manner, e.g., using conventional metallic pattern deposition techniques. In this embodiment, the electrically conductive strips are illustratively oriented so when opposite ends of the flexible or semi-flexible sheet are brought together to form an elongated cylinder the plurality of spaced-apart, parallel, electrically conductive strips form the plurality of charge detection cylinders and the one or more ground rings 18₁ – 18_{N}. Those skilled in the art will recognize other forms in which the drift tube 12A and/or the charge detection cylinders 16₁ – 16_{N} and/or the one or more ground rings 18₁ – 18_{N} (in embodiments which include them) may be provided, and it will be understood the any such other forms are intended to fall within the scope of this disclosure.

In the illustrated embodiment, each charge detection cylinder 16₁ – 16_{N} is electrically connected to a signal input of a corresponding one of N charge sensitive amplifiers CA1 - CAN, and the signal outputs of each charge sensitive amplifier CA1 – CAN is electrically connected to the processor 24. In alternate embodiments, any, some or all of the charge sensitive amplifiers may be electrically connected to more than one charge detection cylinder, and in such embodiments the number of charge sensitive amplifiers will accordingly be less than the number of charge detection cylinders. As charged particles entering the ion inlet A1 move axially through the drift region 12 toward and through the ion outlet A2, each such charged particle passes sequentially through the plurality of charge detection cylinders 16₁ – 16_{N}. As each such charged particle passes through a charge detection cylinder 16₁ – 16_{N}, a charge induced thereby on the charge detection cylinder 16₁ – 16_{N} has a magnitude that is proportional to the magnitude of the charge of that particle. The charge sensitive amplifiers CA1 – CAN are each illustratively conventional and responsive to charges induced by charged particles on a respective one of the charge detectors 16₁ – 16_{N} to produce corresponding charge detection signals at the output thereof, and to supply the charge detection signals to the processor 24. The magnitudes of the charge detection signals produced by the charge sensitive amplifiers CA1 – CAN are, at any point in time, proportional to: (i) in the case of a single charged particle passing through a respective one of the charge detection cylinders 16₁ – 16_{N}, the magnitude of the charge of that single charged particle, or (ii) in the case of multiple charged particles simultaneously passing through a respective one of the charge detection cylinders 16₁ – 16_{N}, the combined magnitudes of the charges of those multiple charged particles. The processor 24 is, in turn, illustratively operable to receive and digitize the charge detection signals produced by each of the charge sensitive amplifiers CA1 – CAN, and to store the digitized charge detection signals in the memory 26 or in one or more other memory units coupled to or otherwise accessible by the processor 24.

The processor 24 is further illustratively coupled via a number, P, of signal paths to one or more peripheral devices 28 (PD), where P may be any positive integer. The one or more peripheral devices 28 may include one or more devices for providing signal input(s) to the processor 24 and/or one or more devices to which the processor 24 provides signal output(s). In some embodiments, the peripheral devices 28 include at least one of a conventional display monitor, a printer and/or other output device, and in such embodiments the memory 26 has instructions stored therein which, when executed by the processor 24, cause the processor 24 to control one or more such output peripheral devices 28 to display and/or record analyses of the stored, digitized charge detection signals.

The ion inlet end of the drift tube 12A, i.e., the end at which the ion inlet A1 is located, is illustratively configured to be coupled to an ion outlet end of an ion source 30, i.e., an end of the ion source 30 at which an ion outlet A5 is located, as illustrated by example in FIG. 1. In embodiments in which the ion source 30 is coupled to the charge filter instrument 10, a second voltage source VS2 is illustratively connected to the ion source 30 via a number, H, of signal paths, where H may be any positive integer, and is further connected to the processor 24 via a number, G, of signal paths, where G may be any positive integer. VS2 may illustratively take any of the forms described above with respect to VS1, such that VS2 may be configured or controlled to produce any number of time invariant, e.g., constant, and/or time-varying output voltages to selectively control one or more aspects of the ion source 30.

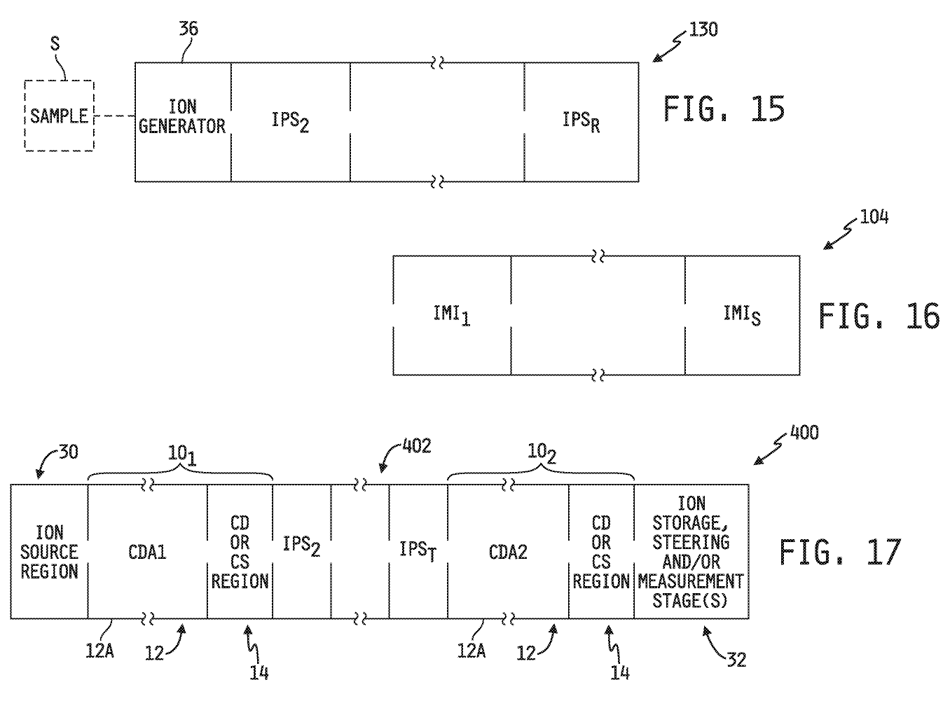

As will be described in greater detail below with respect to FIG. 15, the ion source 30 illustratively includes any conventional device or apparatus for generating ions from a sample and may further include one or more devices and/or instruments for separating, collecting and/or filtering ions according to one or more molecular characteristics and/or for dissociating, e.g., fragmenting, ions. As one illustrative example, which should not be considered to be limiting in any way, the ion source 30 may include a conventional electrospray ionization source, a matrix-assisted laser desorption ionization (MALDI) source or other conventional ion generator configured to generate ions from a sample. The sample from which the ions are generated may be any biological or other material.

The drift region 12 of the charge filter instrument 10 is a field-free drift region (i.e., no electric field) such that ions entering the inlet A1 of the drift tube 12A from the ion source 30 with initial velocities drift toward and through the ion outlet A2 with substantially constant velocities. In this regard, the ion source 30 will typically provide a motive force for passing ions into the drift tube 12A with initial velocities. The motive force may illustratively be provided in any one or combination of several different forms, examples of which may include, but are not limited to, one or more ion-accelerating electric fields, one or more magnetic fields, a pressure differential between the external environment and the ion source 30 and/or a pressure differential between the ion source 30 and the drift tube 12A, or the like. In any case, as the charged particles drift through the field-free drift region 12, they will separate in time according to mass-to-charge ratio with the charged particles having lower mass-to-charge ratios reaching the ion outlet A2 more quickly than the charged particles having higher mass-to-charge ratios.

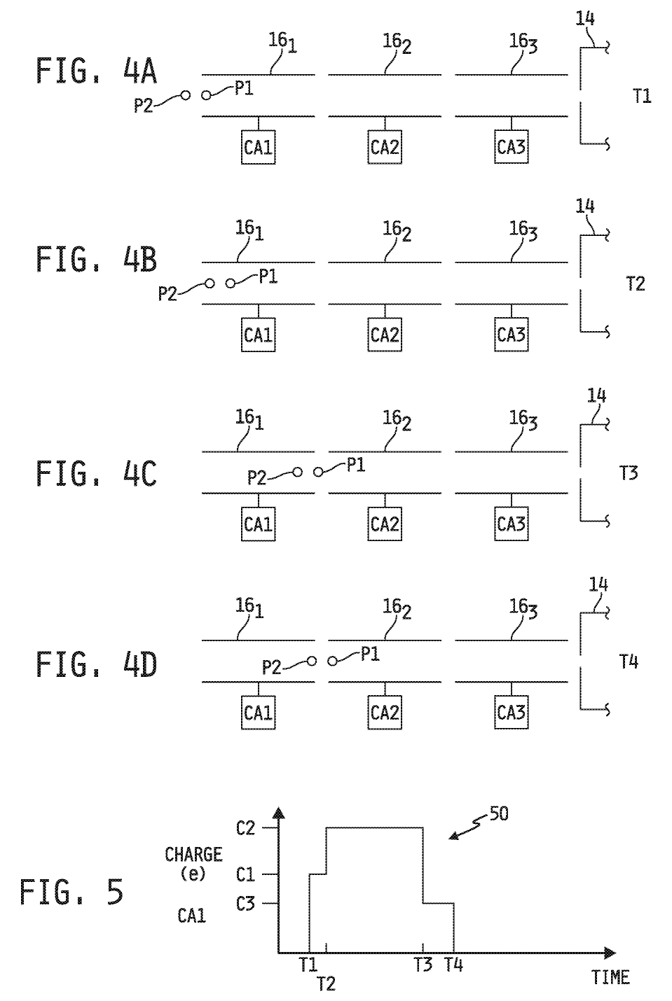

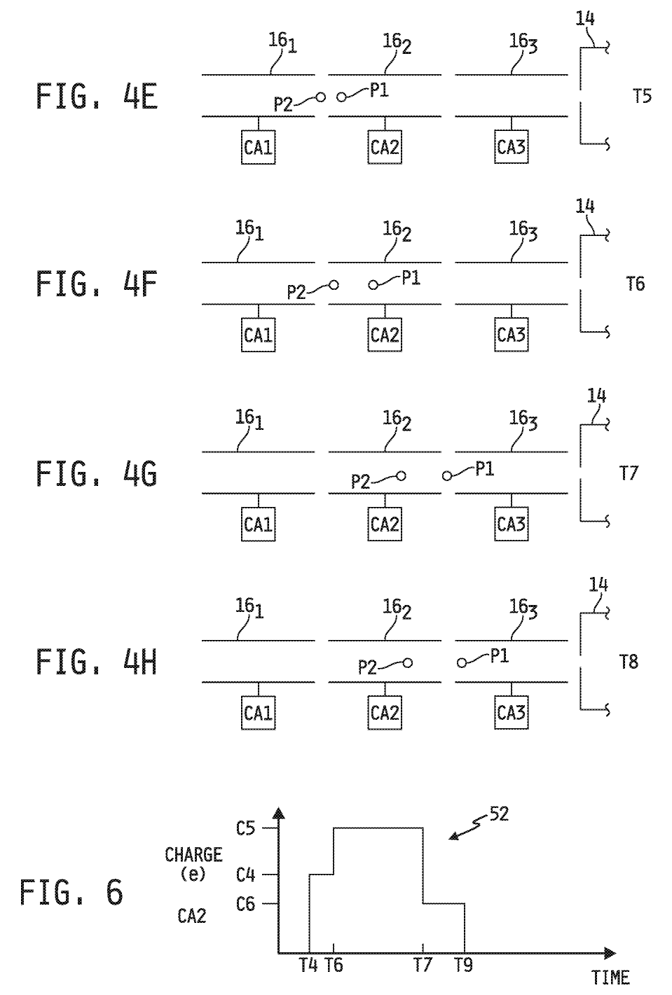

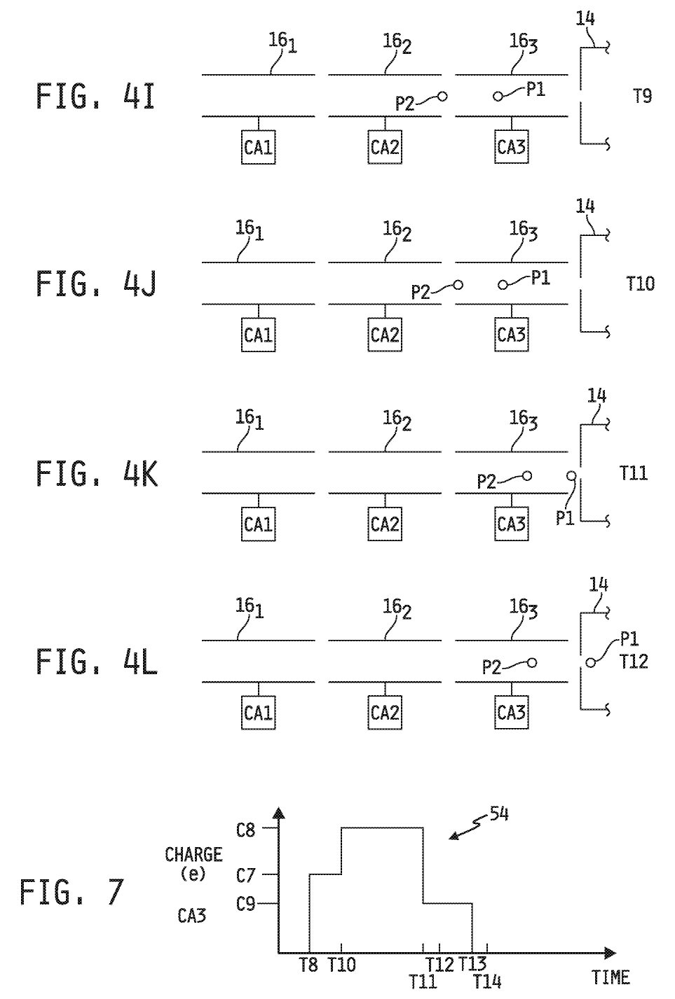

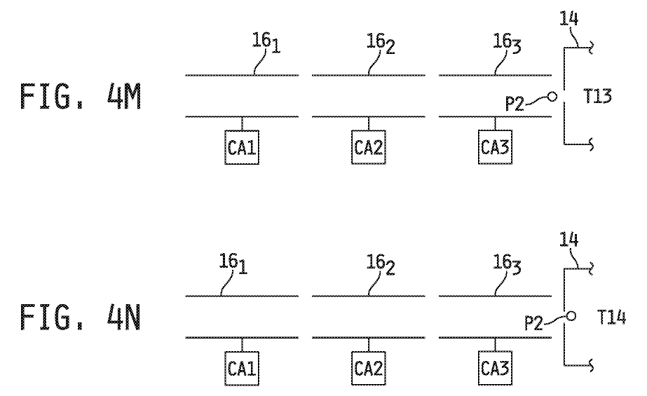

As will be described in detail below with respect to the examples illustrated in FIGS. 4A-7, the memory 26 illustratively has instructions stored therein which are executable by the processor 24 to cause the processor 24 to process the charge detection signals produced by at least some of the charge sensitive amplifiers CA1 – CAN to determine the charge magnitudes and/or charge states of the charged particles as they separate along the length of the drift region 12, so that the charge magnitude and/or charge state of each charged particle is known prior to passing through the ion outlet A2 of the drift tube 12A. In some embodiments, the memory 26 further illustratively has instructions stored therein which are executable by the processor 24 to cause the processor 24 to control the voltage source VS1 to cause the charge deflection or steering region 14 to selectively pass only charged particles having a selected charge magnitude or only charged particles having charge magnitudes within a selected range of charge magnitudes, or to pass only charged particles having a selected charge state. In other embodiments, the memory 26 further illustratively has instructions stored therein which are executable by the processor 24 to cause the processor 24 to control the voltage source VS1 to cause the charge deflection or steering region 14 to selectively steer charged particles having different charge magnitudes, or having charges within different ranges of charge magnitudes, along different ion travel paths, or to selectively steer charged particles having different charge states along different ion travel paths. In some embodiments, it may be desirable to determine the velocities of the charged particles traveling through the drift region 12 so that the future positions of the charged particles within the charge deflection or steering region 14 can be accurately estimated when controlling the voltage source VS1 to selectively pass or steer charged particles through charge deflection or steering region 14.

The ion outlet end of the ion deflection or steering region 14, i.e., the end at which the ion outlet A4 is located, is illustratively configured to be coupled to an ion inlet end of an ion storage, steering and/or measurement stage(s) 32, i.e., an end of the ion inlet end of an ion storage, steering and/or measurement stage(s) 32 at which an ion inlet A6 is located, as illustrated by example in FIG. 1. In embodiments in which the ion storage, steering and/or measurement stage(s) 32 is coupled to the charge filter instrument 10, a third voltage source VS3 is illustratively connected to the ion storage, steering and/or measurement stage(s) 32 via a number, M, of signal paths, where M may be any positive integer, and is further connected to the processor 24 via a number, L, of signal paths, where L may be any positive integer. VS3 may illustratively take any of the forms described above with respect to VS1, such that VS3 may be configured or controlled to produce any number of time invariant, e.g., constant, and/or time-varying output voltages to selectively control one or more aspects of the ion storage, steering and/or measurement stage(s) 32.

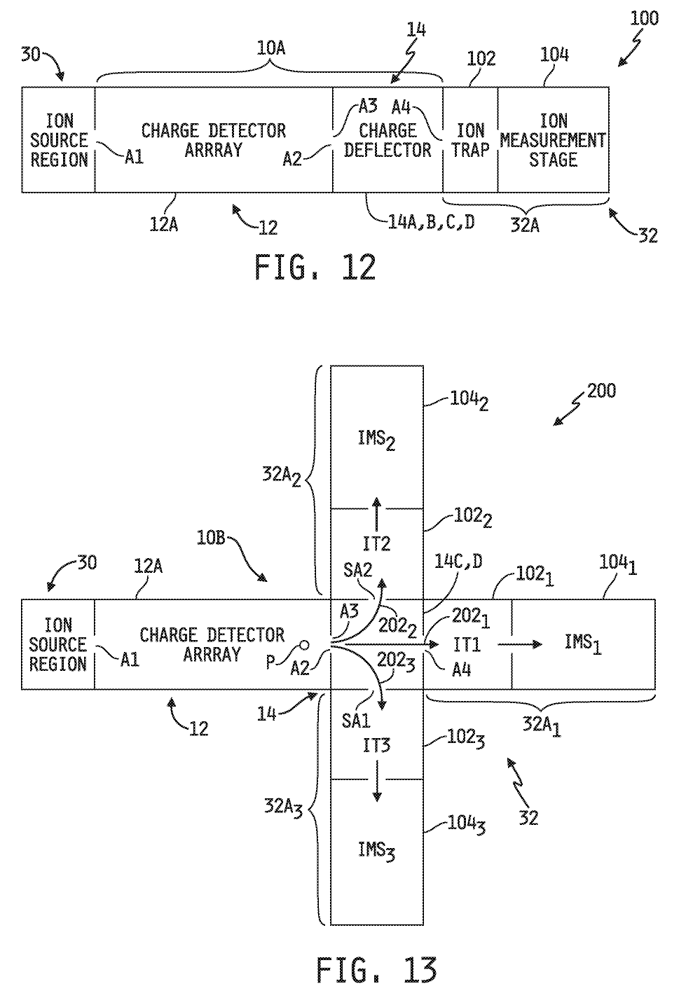

As will be described in greater detail below with respect to the application examples illustrated in FIGS. 12-14 and 16, the ion storage, steering and/or measurement stage(s) 32 may include any conventional device or apparatus for storing ions, for measuring ions, for processing ions following or prior to measurement thereof, and/or for steering ions between one or more devices. The one or more ion measurement instruments, devices, apparatuses or stages are illustratively connected to the processor 24 via a number, Q, of signal paths, where Q may be any positive integer.

As briefly described above, the memory 26 illustratively includes instructions executable by the processor 24 to cause the processor 24 to determine the charge magnitudes and/or charge states of each of the charged particles moving through the drift region 12, and to then control the voltage source VS1 to selectively pass or steer the charged particles through the charge deflection or steering region 14 based on their charge magnitudes or charge states. In some embodiments, such as when the ion source 30 is configured to generate and supply a plurality of ions simultaneously to the ion inlet A1 of the drift tube 12A, for example, it may be desirable to configure the drift tube 12A to include a pre-array space 12B of length PRL between the ion inlet A1 of the drift tube 12A and the first ground ring 18₁ (or the ion inlet end of the first charge detection cylinder 16₁ in embodiments in which the first ground ring 18₁ is omitted), as illustrated by example in FIG. 1. This will allow the charged particles moving axially through the drift region 12 to undergo some amount of axial separation in time (as a function of mass-to-charge ratio in the field-free region 12) prior to conducting charge measurements with the charge detector array 16, and may thereby increase the quality and usefulness of the charge detection signals produced by the first one or more of the charge sensitive amplifiers CA1 – CAN. The length PRL of the pre-array space 12B may illustratively be chosen based on the application, and in some embodiments the pre-array space 12B may be omitted in its entirety. Alternatively or additionally, it may be desirable in some embodiments to configure the drift tube 12A to include a post-array space 12C of length POL between the last ground ring 18_{N} (or the ion outlet end of the last charge detection cylinder 16_{N} in embodiments in which the last ground ring 18_{N} is omitted), as further illustrated by example in FIG. 1. In some such embodiments, some or all of the length POL of the post-array space 12C may be provided in the front end, i.e., adjacent to the ion inlet A3, of the charge deflection or steering array 14. In any case, the post-array space 12C, in embodiments which include it, will provide some amount of time between charge particles passing through the final charge detection cylinder 16_{N} and thereafter exiting the ion outlet A2 of the drift tube 12A, and may thereby relax the decision and control timing and/or switching speed requirements of the charge deflection or steering region 14. The length POL of the post-array space 12C may illustratively be chosen based on the application, and in some embodiments the post-array space 12C may be omitted in its entirety.

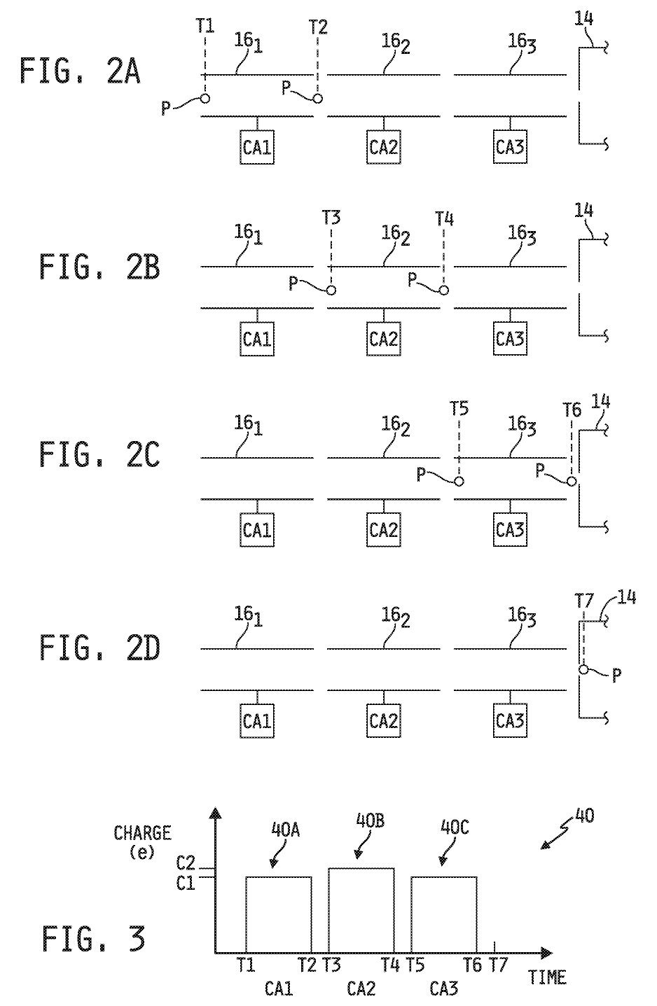

Referring now to FIGS. 2A-2D, a simplified example of the charge filter instrument 10 of FIG. 1 is shown which includes three charge detection cylinders 16₁ – 16₃ axially arranged between the ion inlet A1 of the drift tube 12A and the charge deflection or steering region 14. With this simplified instrument 10, FIGS. 2A-2D depict a single charge particle P drifting successively through each of the three charge detection cylinders 16₁ – 16₃ as a function of time, and FIG. 3 depicts example charge detection signals produced by the three respective charge sensitive amplifiers CA1 – CA3 as the charged particle passes therethrough. As illustrated in FIGS. 2A and 3, the charged particle P enters the first charge detection cylinder 16₁ at a time T1 and exits the charge detection cylinder 16₁ at a subsequent time T2, and while within the charge detection cylinder 16₁ the charged particle induces a charge on the charge detection cylinder 16₁ of magnitude C1. In some embodiments, the time T1 may be a time relative to an ion generation or acceleration event which is controlled at the ion source 30 at a prior time T0. In alternate embodiments, the output signal produced by CA1 may be monitored after an ion generation or acceleration event, and T1 may simply be the time at which the first (and only in this example) particle P is detected, e.g., via the rising edge of the charge detection signal output produced by CA1, as entering the first charge detection cylinder 16₁ following the ion generation or acceleration event. In any case, at a time T3 > T2, the charged particle P having exited the first charge detection cylinder 16₁ now enters the second charge detection cylinder 16₂, and the charged particle P thereafter exits the charge detection cylinder 16₂ at a subsequent time T4, as depicted in FIG. 2B. While within the charge detection cylinder 16₂ the charged particle induces a charge on the charge detection cylinder 16₂ of magnitude C2 as depicted in FIG. 3. At a time T5 > T4, the charged particle P having exited the second charge detection cylinder 16₂ now enters the third and final charge detection cylinder 16₃, and the charged particle P thereafter exits the charge detection cylinder 16₃ at a subsequent time T6, as depicted in FIG. 2C. While within the charge detection cylinder 16₃ the charged particle induces a charge on the charge detection cylinder 16₃ of magnitude C1 as depicted in FIG. 3.

As the charged particle P moves successively through the charge detection cylinders 16₁ – 16₃, as illustrated by example in FIGS. 2A-2C, the processor 24 is illustratively operable, pursuant to execution of corresponding instructions stored in the memory 26, to determine the magnitude and/or the charge state of the charged particle P based on the charge detection signals produced by the charge sensitive amplifiers CA1 – CA3. In one embodiment, the processor 24 is operable to make such a determination based on the charge detection signal produced by the first charge sensitive amplifier CA1, and to then successively update the charge determination based on the charge detection signals produced by the remaining charge sensitive amplifiers CA2 and CA3 after the charged particle passes through the respective charge detection cylinders 16₁ and 16₂. In some embodiments, the processor 24 is further operable, pursuant to execution of corresponding instructions stored in the memory 26, to likewise determine the velocity of the charge particle P based on the charge detection signal produced by the first charge sensitive amplifier CA1, and to then update the velocity determination based on the charge detection signals produced by the remaining charge sensitive amplifiers CA2 and CA3 after the charged particle passes through the respective charge detection cylinders 16₁ and 16₂.

Using this example model, the processor 24 is illustratively operable to determine an initial magnitude of the charge CH of the particle P after the particle P exits the first charge detection cylinder 16₁, e.g., as indicated by the falling edge of CA1, as the magnitude CH = C1 produced by the charge sensitive amplifier CA1 between the rising edge of CA1 at time T1 and the falling edge of CA1 at time T2. In some embodiments, the processor 24 is further operable to determine an initial velocity of the charged particle as Vel_{P} = CDL/(T2 – T1). After detection of the falling edge of CA2 at time T4, the processor 24 is operable to determine an updated magnitude of the charge of the particle P based on the magnitude C2 produced by the charge sensitive amplifier CA2 between the rising edge of CA2 at time T3 and the falling edge of CA2 at time T4 as CH = (CH + C2). In some embodiments, the processor 24 is further operable to determine an updated velocity of the charged particle as Vel_{P} = Vel_{P} + CDL/(T4 – T3). After detection of the falling edge of CA3 at time T6, the processor 24 is operable to determine a final updated magnitude of the charge of the particle P based on the magnitude C1 produced by the charge sensitive amplifier CA3 between the rising edge of CA3 at time T5 and the falling edge of CA3 at time T6 as CH = CH + C3. In some embodiments, the processor 24 is further operable to determine an updated velocity of the charged particle as Vel_{P} = Vel_{P} + (CDL/(T6 – T5)). After the ion has traveled through all of the charge detectors, the average charge is calculated from CH = CH/N, where N is the number of measurements (in this case 3) and the average velocity is calculated from Vel_{P} = Vel_{P}/N.

At the point in time just after T6, the processor 24 has determined the charge magnitude CH, and in some embodiments the velocity Vel_{P}, of the particle P based on the averages of the charge detection signals produced by the charge sensitive amplifiers CA1 – CA3. In some embodiments, the processor 24 may be operable to convert the charge magnitude to a charge state, e.g., by dividing CH by the elementary charge constant e (e.g., 1.602716634 x 10⁻¹⁹ Coulombs), or may be operable to compute the initial and updated charge values as charge state values rather than charge magnitudes. In any case, if the determined charge magnitude or charge state CH is equal to, or within a specified range of, a specified or target charge magnitude or charge state value, the processor 24 is operable to control the voltage source VS1 to apply one or more voltage values to the charge deflection or steering region 14 which causes the charge deflection or steering region 14 to pass the charged particle P therethrough. Otherwise, the processor 24 is operable to control the voltage source VS2 to apply one or more voltage values to the charge deflection or steering region 14 which causes the charge deflection or steering region 14 to prevent passage of the charged particle P therethrough or to steer the charged particle P away from the region 14. In some embodiments of the charge deflection or steering region 14, such control of the voltage source VS1 should occur before the charged particle P enters the region 14 at a time T7 > T6, and in other embodiments such control of the voltage source VS1 may occur after the charged particle P has entered the region 14 but before the charged particle P exits the region 14. In either case, the determined velocity Vel_{P}, in embodiments in which the processor 24 determines Vel_{P}, may be used along with the dimensional information of the drift region 12 and/or the charge deflection or steering region 14 to estimate the future position of the charged particle P entering, within and/or traveling through the region 14 for purposes of determining the timing of control of the voltage source VS1 to pass, prevent passage or steer the charged particle P through the region 14. In alternate embodiments, the processor 24 may base the timing of control of the voltage source VS1 solely on the determined speed Vel_{P} of the charged particle approaching the region 14.

Those skilled in the art will recognize other techniques for determining the magnitude and/or charge state and/or velocity of the charged particle P based on one or more of the charge detection signals produced by the charge sensitive amplifiers CA1-CAN and/or for determining the timing of control of the voltage source VS1 to pass/ prevent passage or steer the charge particle P through the region 14. It will be understood that any such other techniques are intended to fall within the scope of this disclosure.

Referring now to FIGS. 4A-4N, another simplified example of the charge filter instrument 10 of FIG. 1 is shown which includes three charge detection cylinders 16₁ – 16₃ axially arranged between the ion inlet A1 of the drift tube 12A and the charge deflection or steering region 14. With this simplified instrument 10, FIGS. 4A-4N depict two charged particles P1, P2 drifting successively through each of the three charge detection cylinders 16₁ – 16₃ as a function of time, wherein P1 has a slightly lower mass-to-charge ratio than that of P2. FIG. 5 depicts an example charge detection signal produced by the first charge sensitive amplifier CA1 as the charged particles pass therethrough, and FIGS. 6 and 7 depict the same for the second and third charge sensitive amplifiers CA2 and CA3 respectively. As illustrated in FIGS. 4A-4E, the charged particles P1 and P2 enter the first charge detection cylinder 16₁ at times T1 and T2 respectively, where T2 > T1. At time T3 > T2, the charged particle P1 exits the charge detection cylinder 16₁, and at time T5 > T3 the charged particle P2 exits the charge detection cylinder 16₁. With the particle P1 alone moving within the charge detection cylinder 16₁ between T1 and T2, the charged particle P1 induces a charge on the charge detection cylinder 16₁ of magnitude C1 as depicted in FIG. 5. Between T2 and T3 in which both of the charged particles P1 and P2 are moving through the charge detection cylinder 16₁, the charged particles P1 and P2 together induce a charge on the charge detection cylinder 16₁ of magnitude C2 > C1, and between T3 and T5 in which only the charged particle P2 is moving through the charge detection cylinder 16₁, the charged particle P2 induces a charge on the charge detection cylinder 16₁ of C3 < C1.

In the case of multiple charged particles drifting axially through the drift region 12 and thus axially through each successive charge detection cylinder 16₁ – 16_{N}, a process similar to that described above with respect to FIGS. 2A-3 may be used to track ion charge and velocity based on detection by the processor 24 of rising and falling edges of the charge detection signal produced by successive ones of the charge sensitive amplifiers CA1 – CAN. In particular, the instructions stored in the memory 26 may illustratively include instructions executable by the processor 24 to monitor the charge detection signals produced by the charge sensitive amplifiers CA1 – CAN and count each rising edge of a charge detection signal as a single charged particle entering a respective one of the charge detection cylinders 16₁ – 16_{N}, to count each falling edge the charge detection signal as a single charged particle exiting the respective charge detection cylinder 16₁ – 16_{N}, to record the various magnitudes of the charge detection signal as the magnitudes of single ones and combinations of the charged particles and to record the velocities of each of the multiple charged particles based on the rising and falling edges of the charge detection signal.

Using the charge detection signal produced by CA1, for example, the first rising edge is counted as a first charged particle having a charge magnitude equal to the magnitude of the charge detection signal between the first rising edge and the next rising or falling edge. If the next edge event is a falling edge, then the velocity of the first charged particle is equal to the ratio of the length CDL of the charge detection cylinder 16₁ and the difference in time between the rising and falling edges. If instead the next edge event is another rising edge, the second rising edge is counted as a second charged particle having a combined charge magnitude equal to the magnitude of the charge detection signal between the second rising edge and the next rising or falling edge. This process continues with each rising edge. Upon detection of the first falling edge, this is counted as the first charged particle exiting the charge detection cylinder 16₁, the velocity of the first charged particle is equal to the ratio of the length CDL of the charge detection cylinder 16₁ and the difference in time between the first rising edge and the first falling edge, and the magnitude of the charge detection signal produced by CA1 after the first falling edge is the combined charge magnitude of the charged particles remaining in the charge detection cylinder 16₁. This process continues until the last falling edge of the charge detection signal produced by CA1, and the same process is executed with respect to the charge detection signals produced by each of the remaining charge sensitive amplifiers CA1 – CAN.

Referring again to FIG. 5, the processor 24 executing the above-described process is operable to determine that the charge CH_{P1} of the first charged particle P1 between T1 and T2 is C1, the combined charge CH_{P1P2} of the charged particles P1 and P2 between T2 and T3 is C2 and the charge CH_{P2} of the second charged particle P2 between T3 and T5 is C3. In embodiments in which the velocities of the charged particles passing through the charge detection cylinder 16₁ are determined by the processor 24 as part of the above-described process, the processor 24 is operable to determine the velocity of the first charged particle P1 as Vel_{P1} = CDL/(T3-T1), and to determine the velocity of the second charged particle P2 as Vel_{P2} = CDL/(T5-T2). In some embodiments, the processor 24 may be operable to modify CH_{P1} and CH_{P2} such that CH_{P1} and CH_{P2} further satisfy the measured relationship CH_{P1} + CH_{P2} = C2. In alternate embodiments, such modification of CH_{P1} and CH_{P2} may be factored into the charge magnitude values CH_{P1} and CH_{P2} following processing of charge detection signals produced by one or more, or all, of the downstream charge sensitive amplifiers CA2 – CAN.

As illustrated in FIGS. 4D-4I, the charged particles P1 and P2 enter the second charge detection cylinder 16₂ at times T4 and T6 respectively, where T6 > T4 > T3. At time T7 > T6, the charged particle P1 exits the charge detection cylinder 16₂, and at time T9 > T7 the charged particle P2 exits the charge detection cylinder 16₂. With the particle P1 alone moving within the charge detection cylinder 16₂ between T4 and T6, the charged particle P1 induces a charge on the charge detection cylinder 16₂ of magnitude C4 as depicted in FIG. 6. Between T6 and T7 in which both of the charged particles P1 and P2 are moving through the charge detection cylinder 16₂, the charged particles P1 and P2 together induce a charge on the charge detection cylinder 16₂ of magnitude C5 > C4, and between T7 and T9 in which only the charged particle P2 is moving through the charge detection cylinder 16₂, the charged particle P2 induces a charge on the charge detection cylinder 16₂ of C6 < C4. Again using the above-described process, the processor 24 is operable to update the charge CH_{P1} of the first charged particle P1 as CH_{P1} = CH_{P1} + C4, to update the charge CH_{P2} of the second charged particle P2 as CH_{P2} = CH_{P2} + C6, and to determine the combined charge CH_{P1P2} of the charged particles P1 and P2 between T6 and T7 is C5. In embodiments in which the velocities of the charged particles passing through the charge detection cylinder 16₂ are determined by the processor 24 as part of the above-described process, the processor 24 is operable to update the velocity of the first charged particle P1 as Vel_{P1} = Vel_{P1} + CDL/(T7-T4), and to update the velocity of the second charged particle P2 as Vel_{P2} = Vel_{P2} + CDL/(T9-T6). In some embodiments, the processor 24 may be operable to modify CH_{P1} and CH_{P2} such that CH_{P1} and CH_{P2} further satisfy the measured relationship CH_{P1} + CH_{P2} = C5. In alternate embodiments, such modification of CH_{P1} and CH_{P2} may be factored into the charge magnitude values CH_{P1} and CH_{P2} following processing of charge detection signals produced by one or more, or all, of the downstream charge sensitive amplifiers CA3 – CAN.

As illustrated in FIGS. 4H-4M, the charged particles P1 and P2 enter the third charge detection cylinder 16₃ at times T8 and T10 respectively, where T10 > T8 > T7. At time T11 > T10, the charged particle P1 exits the charge detection cylinder 16₃, and at time T13 > T11 the charged particle P2 exits the charge detection cylinder 16₃. At the time T12, where T11 < T12 < T13 such that the second charged particle P2 is still within the third charge detection cylinder 16₃, the first charged particle P1 enters the charge deflection or steering region 14 as depicted in FIG. 4L, and at the time T14 > T13, the second charged particle P2 enters the charge deflection or steering region 14. With the particle P1 alone moving within the charge detection cylinder 16₃ between T8 and T10, the charged particle P1 induces a charge on the charge detection cylinder 16₃ of magnitude C7 as depicted in FIG. 7. Between T10 and T11 in which both of the charged particles P1 and P2 are moving through the charge detection cylinder 16₃, the charged particles P1 and P2 together induce a charge on the charge detection cylinder 16₃ of magnitude C8 > C7, and between T11 and T13 in which only the charged particle P2 is moving through the charge detection cylinder 16₃, the charged particle P2 induces a charge on the charge detection cylinder 16₃ of C9 < C7.

Again using the above-described process, the processor 24 is operable to update the charge CH_{P1} of the first charged particle P1 between T11 and T12 as CH_{P1} = CH_{P1} + C7. In embodiments in which the velocities of the charged particles passing through the charge detection cylinder 16₃ are determined by the processor 24 as part of the above-described process, the processor 24 is further operable between T11 and T12 to update the velocity of the first charged particle P1 as Vel_{P1} = Vel_{P1} + CDL/(T11-T8). As the charge detection cylinder 16₃ is the final charge detection cylinder in the example illustrated in FIGS. 4A-4N, the value of CH_{P1} at a time between T11 and T12 is the final measured value of the charge magnitude of the first charged particle P1 and, in embodiments which include it, the value Vel_{P1} at the time between T11 and T12 is the final measured value of the velocity of the first charged particle P1. The average charge is calculated from CH_{P1} = CH_{P1}/N, where N is the number of measurements (in this case 3) and the average velocity is calculated from Vel_{P1} = Vel_{P1}/N. Prior to the first charged particle P1 entering the charge deflection or steering region 14, the processor 24 is operable to compare CH_{P1} to one or more target charge magnitude values, or to compute the charge state CS_{P1} of the first charged particle P1 (CS_{P1} = CH_{P1}/e) and compare CS_{P1} to one or more target charge states, and to then control the voltage source VS1 at or after T12, but before T14, to pass/block the first charged particle P1 or to steer the first charged particle P1 along one of multiple different paths of the region 14 based on the outcome of the comparison of CH_{P1} or CS_{P1} with the one or more target charge magnitudes or target charge states. In embodiments in which the particle velocities are computed, the timing of such control by the processor 24 of the voltage source VS1 may be based on, or at least take into account, the velocity Vel_{P1} of the charged particle P1 and/or an estimated future position of the charged particle P1, based on Vel_{P1} and dimensional information of the charge filter instrument 10, relative to and/or within the charge deflection or steering region 14.

The processor 24 is subsequently operable between T13 and T14 to update the charge CH_{P2} of the second charged particle P2 as CH_{P2} = CH_{P2} + C9. In some embodiments, the processor 24 may be further operable between T13 and T14 to modify CH_{P2} in order to satisfy the measurement CH_{P1} + CH_{P2} = C8 produced by the charge sensitive amplifier CA3. In embodiments in which the velocities of the charged particles passing through the charge detection cylinder 16₃ are determined by the processor 24 as part of the above-described process, the processor 24 is further operable between T13 and T14 to update the velocity of the second charged particle P2 as Vel_{P2} = Vel_{P2} + CDL/(T13-T10). Again, as the charge detection cylinder 16₃ is the final charge detection cylinder in the example illustrated in FIGS. 4A-4N, the value of CH_{P2} at a time between T13 and T14 is the final measured value of the charge magnitude of the second charged particle P2 and, in embodiments which include it, the value Vel_{P2} at the time between T13 and T14 is the final measured value of the velocity of the second charged particle P2. The average charge is calculated from CH_{P2} = CH_{P2}/N, where N is the number of measurements (in this case 3) and the average velocity is calculated from Vel_{P2} = Vel_{P2}/N. Following entrance of the first charged particle P1 into the charge deflection or steering region 14 at T12 and, in some embodiments, control by the processor 24 of the voltage source VS1 to cause the charge deflection or steering region 14 to pass/block or steer the first charged particle P1, and in any case prior to the second charged particle P2 entering the charge deflection or steering region 14, the processor 24 is operable to compare CH_{P2} to one or more target charge magnitude values, or to compute the charge state CS_{P2} of the second charged particle P2 (CS_{P2} = CH_{P2}/e) and compare CS_{P2} to one or more target charge states, and to then control the voltage source VS1 at or after T14 to pass/block the second charged particle P2 or to steer the second charged particle P2 along one of multiple different paths of the region 14 based on the outcome of the comparison of CH_{P2} or CS_{P2} with the one or more target charge magnitudes or target charge states. In embodiments in which the particle velocities are computed, the timing of such control by the processor 24 of the voltage source VS1 may be based on, or at least take into account, the velocity Vel_{P2} of the charged particle P2 and/or an estimated future position of the charged particle P2, based on Vel_{P2} and dimensional information of the charge filter instrument 10, relative to and/or within the charge deflection or steering region 14.

It will be understood that the examples illustrated in FIGS. 2A-7 are provided only for the purpose of describing operation of the charge filter instrument 10, and are not intended to be limiting in any way. Those skilled in the art will appreciate that the above-described process, or variant thereof, may be applied directly to the determination of charge magnitudes, charge states and/or velocities and of passing/blocking and/or steering of many charged particles, e.g., hundreds, thousands or more. Alternatively, those skilled in the art will recognize other techniques for determining the magnitude and/or charge state and/or velocity of the multiple charged particles based on one or more of the charge detection signals produced by the charge sensitive amplifiers CA1-CAN and/or for determining the timing of control of the voltage source VS1 to pass/ prevent passage or steer the charge particle P through the region 14, and it will be understood that any such other techniques are intended to fall within the scope of this disclosure. For example, in some embodiments the charge detection signals produced by the charge sensitive amplifiers CA1-CAN may be differentiated. A positive-going pulse will result each time an ion enters a charge detection cylinder, and a negative-going ion will result each time an ion exits a charge detection cylinder. If the rise and fall times of the output signals of the charge sensitive amplifiers CA1-CAN (e.g., see FIGS. 3, 5, 6 and 7) are much shorter than the time constant for differentiation, then the charge is given by the peak height. If, on the other hand, the rise and fall times are much longer than the time constant for differentiation, then the charge is given by the peak area. The amplitudes of the positive-going and negative-going pulses associated with any particular ion should be the same, and this provides an identifier to pair up positive-going and negative-going pulses so that the velocities and average charges can be determined. This alternative data analysis technique may be advantageous when, for example, the number of ions drifting through the drift tube 16A is large.

It will be further understood that in the charge filter instrument 10 illustrated in FIG. 1, not all of the charge detection signals may be used to determine particle charge values and/or particle velocities. In some embodiments in which charged particles may be bunched together exiting the ion source 30, for example, the charge detection signals produced by the first one or several charge sensitive amplifiers may be ignored by the processor 24. Alternatively or additionally, the drift tube 12A may be configured to include the pre-array space 12B of any desired length to allow such bunched particles to at least begin to separate in the axial direction of the drift region 12 prior to passing through the first of multiple charge detection cylinders 16₁ – 16_{N}. As another example, the processor 24 may be configured or programmed to conclude charge value and/or particle velocity determinations before the charged particles reach the last charge detection cylinder 16_{N} or before the charged particles reach the last several charge detection cylinders 16_{N-Y} – 16_{N}, where Y may be any positive integer less than N. Alternatively or additionally, the drift tube 12A may be configured to include the post-array space 12C of any desired length in order to relax the timing requirements for the control of the voltage source VS1 following determination of particle charge values and/or velocities. As yet another example, the processor 24 may be configured or programmed in some embodiments to determine only the charge values, i.e., not determine particle velocity values, and to base control of the voltage source VS1 solely on the charge value determinations and, in some embodiments, dimensional information of the charge filter instrument 10.

As briefly described above, the charge deflection and steering region 14 is controllable, i.e., by controlling the voltage source VS1, to pass, block or steer ions based on their charge magnitudes or charge states. In this regard, ions of a particular charge magnitude, of a particular charge state, having charges within a specified range of charge magnitudes or having computed charge states within a specified range or ranges of one or more particular integer charge states, may be analyzed and/or collected for analysis of one or more molecular characteristics. Because all such ions will have a common charge magnitude or charge state that is known as a result of the charge measurement information produced by the charge sensitive amplifiers CA1 – CAN, the known ion charge magnitudes and/or charge states of such ions may be used in any such downstream analysis to determine molecular characteristic information not previously determinable by conventional instruments. For example, in one non-limiting example application in which the charge filter instrument 10 is controlled, e.g., as described above, to pass only ions having a +1 charge state, then such charge information can be used to directly determine particle mass values using a conventional mass spectrometer or mass analyzer which measures ion mass-to-charge ratio. As another non-limiting example application in which the charge filter instrument 10 is controlled, e.g., as described above, to pass only ions having a +1 charge state, such charge information can be used to directly determine particle mobility values using a conventional ion mobility spectrometer which measures ion mobility as a function of particle charge. As yet another non-limiting example, the charge filter instrument 10 may be configured and controlled, e.g., as described above, to steer and analyze, or collect for analysis, different sets of ions each having different charge magnitudes or different states, e.g., +1, +2, +3, etc. The known charge magnitude or charge state of each such set may then be used with one or more molecular analysis stages to determine one or more molecular characteristics of the set, e.g., particle mass, particle mobility, etc.

Referring now to FIG. 8, an embodiment is shown of the charge deflection or steering region 14 of the charge filter instrument illustrated in FIGS. 1, 2A-2D and 4A-4N. In the illustrated embodiment, the charge deflection or steering region 14 is implemented in the form of a single inlet, single outlet charge deflector 14A configured and controllable to selectively pass or block passage of ions therethrough. The charge deflector 14A includes a pair of electrically conductive members 60, 62 each of length DL, illustratively in the form plates, grids or other electrically conductive material(s), spaced apart from one another to define a channel 64 therethrough between the single ion inlet A3 and the single ion outlet A4. In the illustrated embodiment, the members 60, 62 are depicted as planar components such that the channel 64 is a square or rectangular channel. In alternate embodiments, the electrically conductive members 60, 62 may be implemented in other shapes without limitation. In any case, a first voltage output V1 of the voltage source VS1 is electrically connected to the electrically conductive member 62, and a second voltage output V2 of the voltage source VS1 is electrically connected to the electrically conductive member 60. In one embodiment, the voltages V1 and V2 may be switchable DC voltages, or one of the voltages V1, V2 may be set to a reference potential, e.g., ground or other reference potential, and the other voltage V1, V2 may be a switchable DC voltage. In alternate embodiments, the voltage V1 and/or the voltage V2 may be a time-varying voltage.

In any case, the charge deflector 14A is illustratively operable to deflect a charged particle P entering the inlet A3 into one or the other of the members 60, 62 by controlling the voltage(s) V1 and/or V2 to create an electric field E of sufficient magnitude to divert and accelerate the charged particle P into the member 60, 62 as illustrated by example in FIG. 8. Conversely, the charge deflector 14A is illustratively operable to pass the charged particle P entering the inlet A3 to, and through, the outlet A4, as depicted in dashed-line representation in FIG. 8, so long as an electric field E is not established between the members 60, 62 or an electric field E is established between the members 60, 62 but is not of sufficient magnitude to deflect the charged particle P into one or the other of the members 60, 62. In one illustrative example, which should not be considered limiting in any way, in which the charged particle P has a positive charge, V1=V2= 0 volts (ground potential) to pass the charged particle P through the channel 64, and V1= 0 volts, V2= +Z volts to deflect the charged particle P toward and into the electrically conductive member 62, wherein Z is selected to establish an electric field E between the members 60, 62 with sufficient magnitude to guide and accelerate the charged particle P onto the surface of the member 62 before the charged particle P reaches the outlet A4 to thereby block passage the charged particle P through the charge deflector 14A. It will be understood that in alternate embodiments, the roles of V1 and V2 may be reversed. In other alternate embodiments, the electric field E may be a time-varying electric field established by one or more time-varying voltages V1, V2.

Referring now to FIGS. 9A and 9B, another embodiment is shown of the charge deflection or steering region 14 of the charge filter instrument illustrated in FIGS. 1, 2A-2D and 4A-4N. In the embodiment illustrated in FIGS. 9A and 9B, the charge deflection or steering region 14 is implemented in the form of another single inlet, single outlet charge deflector 14B configured and controllable to selectively pass or block passage of ions therethrough. The charge deflector 14B is illustratively provided in the form of a quadrupole filter including four elongated electrically conductive rods 70, 72, 74, 76 each of length RL and radially spaced apart from one another to define a channel 78 therethrough between the single ion inlet A3 and the single ion outlet A4. In the illustrated embodiment, the rods 70-76 are depicted as cylindrical rods having generally circular cross-sectional shapes, although in alternate embodiments the rods 70-76 may have non-circular cross-sectional shapes. In any case, a first voltage output V1 of the voltage source VS1 is electrically connected to the electrically conductive rods 70 and 72, and a second voltage output V2 of the voltage source VS1 is electrically connected to the electrically conductive rods 74, 76, wherein the rod 70 is positioned radially opposite the rod 72 and the rod 74 is positioned radially opposite the rod 76. In one embodiment, the voltages V1 and V2 may include time-varying voltages, e.g., RF voltages, 180 degrees out of phase with one another and may further include a DC voltage between the rod pairs 70, 72 and 74, 76. In some alternate embodiments, V1 and V2 may include only time-varying, e.g., RF, voltages, and in other alternate embodiments V1 and V2 may include only DC voltages.

In any case, the charge deflector 14B is illustratively operable to deflect a charged particle P entering the inlet A3 into one of the rods 70-76 by controlling the voltage(s) V1 and/or V2 in a conventional manner to create a non-resonant electric field E between the rods 70-76 of sufficient magnitude to divert the charged particle P into one of the rods 70-76 to thereby block passage of the charged particle P through the charge deflector 14B. Conversely, the charge deflector 14B is illustratively operable to pass the charged particle P entering the inlet A3 to, and through, the outlet A4 by controlling the voltage(s) V1 and/or V2 in a conventional manner to create a resonant electric field E between the rods 70-76 which confines the charged particle P within the channel 78 and thus allows the charged particle P entering the inlet A3 to pass axially through the channel 78 and exit through ion outlet A4. In some alternate embodiments, the charge deflector 14B may be used in combination with one or more other charge deflection or steering components to pass only ions having mass-to-charge ratios above a threshold mass-to-charge ratio, e.g., by controlling V1 and V2 to supply only time-varying voltages (i.e., no DC voltages).

Referring now to FIGS. 10A and 10B, yet another embodiment is shown of the charge deflection or steering region 14 of the charge filter instrument illustrated in FIGS. 1, 2A-2D and 4A-4N. In the embodiment illustrated in FIGS. 10A and 10B, the charge deflection or steering region 14 is implemented in the form of a single inlet, multiple-outlet charge steering device 14C configured and controllable to selectively steer ions entering the inlet A3 through one of multiple different ion outlets. The charge steering device 14C is illustratively provided in the form of a single-inlet, three-outlet quadrupole charge steering device having four elongated electrically conductive arcuate members 80, 82, 84, 86 spaced apart from one another to define an ion steering space 88 therebetween. Each of the electrically conductive arcuate members 80, 82, 84, 86 has a convex surface facing the steering space 88 with the members 80, 82 positioned opposite one another on either side of the space 88 and with the members 84, 86 also positioned opposite one another on either side of the space 88. Each adjacent pair of arcuate members defines an ion inlet or outlet therebetween. For example, the arcuate members 80 and 84 are radially spaced apart from one another to define the ion inlet A3 of the steering device 14B therebetween, and the arcuate members 82 and 86 are likewise radially spaced apart from one another to define one ion outlet A4 therebetween which is axially opposite the ion inlet A3. The arcuate members 80 and 86 are axially spaced apart from one another to define one side outlet SA1 therebetween, and the arcuate members 82, 84 are likewise axially spaced apart from one another to define another side outlet SA2 therebetween which is radially opposite the side outlet SA1.

In the embodiment illustrated in FIG. 10B, a first voltage output V1 of the voltage source VS1 is electrically connected to the electrically conductive members 80 and 82, and a second voltage output V2 of the voltage source VS1 is electrically connected to the electrically conductive members 84 and 86. In one embodiment, the voltages V1 and V2 may include time-varying voltages, e.g., RF voltages, 180 degrees out of phase with one another and may further include a DC voltage between the rod pairs 80, 82 and 84, 86. In some alternate embodiments, V1 and V2 may include only time-varying, e.g., RF, voltages, and in other alternate embodiments V1 and V2 may include only DC voltages. In one illustrative implementation, the voltages V1 and V2 are switchable DC voltages, and the processor 24 is illustratively operable to control V1 and V2 to the same voltage, e.g., ground or other potential, to cause the charged particle P entering the inlet A3 to pass directly through the space 88 along a linear axis 85 and through the ion outlet A4 as illustrated by dashed lines in FIG. 10B. Alternatively, assuming the charged particle P has a positive charge, the processor 24 may be operable to control V1 to a negative potential and to control V2 to an opposite positive potential to create an electric field within the space 88 configured to steer the charged particle P entering the ion inlet A3 along an arcuate path 87A and exit the charge steering device 14B through the side exit SA1 as also illustrated in FIG. 10B. Alternatively still, again assuming the charged particle P has a positive charge, the processor 24 may be operable to control V1 to a positive potential and to control V2 to an opposite negative potential to create an electric field within the space 88 configured to steer the charged particle P entering the ion inlet A3 along an arcuate path 87B and exit the charge steering device 14B through the side exit SA2 as further illustrated in FIG. 10B.

Referring now to FIG. 11, a further embodiment is shown of the charge deflection or steering region 14 of the charge filter instrument illustrated in FIGS. 1, 2A-2D and 4A-4N. In the embodiment illustrated in FIG. 11, the charge deflection or steering region 14 is implemented in the form of another single inlet, multiple-outlet charge steering device 14D configured and controllable to selectively steer ions entering the inlet A3 through one of multiple different ion outlets. The charge steering device 14D is illustratively includes a pattern of 4 substantially identical and spaced apart electrically conductive pads C1 – C4 formed on an inner major surface 90A of one substrate 90 having an opposite outer major surface 90B, and an identical pattern of 4 substantially identical and spaced apart electrically conductive pads C1 – C4 formed on an inner major surface 92A of another substrate 92 having an opposite outer surface 92B. The inner surfaces 90A, 92A of the substrates 90, 92 are spaced apart in a generally parallel relationship, and the electrically conductive pads C1 – C4 of the substrate 90 are juxtaposed over respective ones of the electrically conductive pads C1 – C4 of the substrate 92. The spaced-apart, inner major surfaces 90A and 92A of the substrates 90, 92 illustratively define a channel or space 94 therebetween of width D_{P}. In one embodiment, the width, D_{P}, of the channel 94 is approximately 5 cm, although in other embodiments the distance D_{P} may be greater or lesser than 5 cm.

The opposed pad pairs C1, C1 and C3, C3 define the ion inlet A3 therebetween, and the opposed pad pairs C2, C2 and C4, C4 define the ion outlet A4 therebetween. The opposed pad pairs C1, C1 and C2, C2 define a side outlet SA1 therebetween, and the opposed pad pairs C3, C3 and C4, C4 define an opposite side outlet SA2, all similarly as described with respect to the embodiment illustrated in FIGS. 10A and 10B. Edges 90C, 92C of the substrates 90, 92 are illustratively aligned with one another, as are edges 90D, 92D, edges 90E, 92E and edges 90F, 92F.

A first voltage output V1 of the voltage source VS1 is electrically connected to the electrically conductive pad pairs C1, C1 and C4, C4, and a second voltage output V2 of the voltage source VS1 is electrically connected to the electrically conductive pad pairs C2, C2 and C3, C3. In one embodiment, the voltages V1 and V2 may be switchable DC voltages controllable to selectively establish an ion-steering electric field between various one of the pad pairs C1, C1, C2, C2, C3, C3 and C4, C4. In one implementation, the processor 24 is illustratively operable to control V1 and V2 to the same voltage, e.g., ground or other potential, to cause the charged particle P entering the inlet A3 to pass directly through the space channel 94 along a linear axis 96 and through the ion outlet A4 as illustrated in FIG. 11. Alternatively, assuming the charged particle P has a positive charge, the processor 24 may be operable to control V1 to a negative potential and to control V2 to an opposite positive potential to create an electric field within the channel 96 configured to steer the charged particle P entering the ion inlet A3 along an arcuate path 98A and exit the charge steering device 14B through the side exit SA1 as also illustrated in FIG. 11. Alternatively still, again assuming the charged particle P has a positive charge, the processor 24 may be operable to control V1 to a positive potential and to control V2 to an opposite negative potential to create an electric field within the channel 94 configured to steer the charged particle P entering the ion inlet A3 along an arcuate path and exit the charge steering device 14B through the side exit SA2.

Referring now to FIG. 12, an embodiment is shown of a particle measurement device 100 which includes an embodiment 10A of the charge filter instrument 10 illustrated in FIG. 1 and described above. In the embodiment illustrated in FIG. 12, the charge filter instrument 10A includes the drift region 12 having an ion inlet A1 with the charge detector array 16 including the plurality of charge detection cylinders 16₁ – 16_{N} axially arranged within the drift tube 12A between the ion inlet A1 and ion outlet A2 thereof as described above, and further includes the charge deflection or steering region 14 coupled to the outlet end of the drift tube 12A in the form of a charge deflector. The charge deflector may illustratively be implemented as either of the charge deflectors 14A, 14B illustrated in FIGS. 8 and 9A-9B respectively, or as either of the charge steering devices 14C, 14D illustrated in FIGS. 10A-10B and 11 respectively. In the latter case, the charge steering device, e.g., 14C or 14D, is illustratively controlled to operate as a charge deflector to either pass ions entering the ion inlet A3 toward and through the ion outlet A4 or to block ion passage through the ion outlet A4 by steering such ions away from the ion outlet A4, e.g., through either of the side outlets SA1, SA2. Alternatively or additionally, the charge deflector illustrated in FIG. 12 may be implemented in the form of one or more other conventional charge deflectors, charge diverters, charge steering devices or other devices which may be controlled as described above to selectively pass ions entering the ion inlet A3 toward and through the ion outlet A4 or to selectively block ions entering the ion inlet A3 from passing through the ion outlet A4 using any conventional structures and/or techniques.

The particle measurement device 100 further includes an ion source region 30 operatively coupled to the ion inlet end of the charge filter instrument 10A. The ion source region 30 is as described above with reference to FIG. 1 and illustratively includes at least one ion generator coupled to the voltage source VS2 and configured to be responsive to control signals produced by the processor 24 to generate ions from a sample positioned within or outside of the ion source region 30, and further includes one or more conventional structures and/or devices for accelerating or otherwise propelling the generated ions through the ion inlet A1 and into the charge filter instrument 10A. In some embodiments, for example, the ion source region 30 may include at least one ion acceleration structure or region separate from or part of the ion generator and operatively coupled to the voltage source VS2 (see FIG. 1). In this embodiment, the processor 24 may illustratively be programmed to control of the voltage source VS2 to selectively establish an ion accelerating electric field with the ion acceleration structure or within the ion acceleration region which is, in any case, oriented to accelerate the generated ions into the charge filter instrument 10A via the ion inlet A1. As another example in which the sample is contained within the ion source region 30, the drift region 12 may be pumped, e.g., via one or more conventional pumps, to a lower pressure than that of the ion source region 30, and in such embodiments the differential pressure between the ion source region 30 and the drift region 12 may propel the generated ions into the charge filter instrument 10A via the ion inlet A1. As still another example in which the sample is outside of the ion source region 30, the ion source region and/or the drift region 12 may be pumped, e.g., via one or more conventional pumps, to a pressure that is lower than ambient or atmospheric pressure in which the sample is located, and in such embodiments the differential pressure between ambient or atmospheric pressure external to the ion source region 30 and the lower pressure environment within the ion source region and/or drift region 12 may propel the generated ions into the charge filter instrument 10A via the ion inlet A1. In still other embodiments, a combination of differential pressure and an ion acceleration region or structure may be used to provide the motive force for accelerating or otherwise propelling the generated ions into the charge filter instrument 10A.

In some embodiments, the ion source region 30 may include one or more ion separation instruments or stages and/or one or more ion processing instruments or stages in any combination. Some examples of various compositions of the ion source region 30 will be described in detail below with respect to FIG. 15.

The particle measurement device 100 further includes an ion storage, steering and/or measurement stage(s) 32 operatively coupled to the ion outlet end of the charge filter instrument 10A as illustrated in FIG. 1 and briefly described above. In the embodiment illustrated in FIG. 12, the ion storage, steering and/or measurement stage(s) 32 is illustratively implemented in the form of an ion storage and measurement stage 32A including a conventional ion trap 102 operatively coupled to the voltage source VS3 (see FIG. 1) and having an ion inlet coupled to the ion outlet A4 of the charge filter instrument 10A and an ion outlet coupled to an ion inlet of an ion measurement stage 104. In some alternate embodiments, the ion trap 102 may be omitted such that the ion outlet A4 of the charge filter instrument 10A is coupled directly to the ion inlet of the ion measurement stage 104. The ion measurement stage 104 may, in any case, illustratively include one or more conventional instruments or stages for separating ions in time according to one or more molecular characteristics. In some embodiments, the ion measurement stage 104 may further include one or more ion processing instruments or stages in any combination with the one or more ion separating instruments or stages. The ion measurement stage 104 is operatively coupled to the voltage source VS3 as illustrated in FIG. 1. Some examples of various compositions of the ion measurement stage 104 will be described in detail below with respect to FIG. 16.

In the embodiment illustrated in FIG. 12, ions are supplied by the ion source region 30 to the charge filter instrument 10A where the processor 24 is operable to determine particle charge values, and particle velocities in some embodiments, as the ions separate while drifting through the drift region 12 as described above, and to further control the voltage source VS1, as also described above, to pass only ions having a target charge magnitude, having a charge magnitude that is within a selected threshold or range of the target charge magnitude, having a target charge state or having a charge state that is within a selected threshold or range of the target charge state (individually and collectively referred to herein as a “target charge”). In one example implementation in which the charged particle measurement device 100 includes the ion trap 102, the processor 24 is illustratively programmed, e.g., via instructions stored in the memory 26, to control the voltage source VS3 to collect and store ions within the ion trap 102 having the target charge and therefore selected by the processor 24 to pass through the charge deflector 14A, B, C, D and into the ion trap 102. The processor 24 is illustratively configured to control the voltage source VS3 to collect and store ions within the ion trap 102 for any period of time. At some point in time after the ion trap 102 has been operating to collect and store ions therein, the processor 24 is operable to control the voltage source VS3 to eject the collected ions into the ion inlet of the ion measurement stage 104, and the processor 24 is thereafter operable to control the voltage source VS3 in a conventional manner to control operation of the one or more ion measurement instruments making up the ion measurement stage 104 to measure one or more molecular characteristics of the collection of ions all having the target charge. In alternate embodiments which do not include the ion trap 102, ions with the target charge exiting the charge filter instrument 10A are supplied directly to the ion measurement stage 104 where the processor 24 is operable to control the voltage source VS3 to measure one or more molecular characteristics of the exiting ions. In either case, the processor 24 is further operable to collect, store and analyze the ion measurement information produced by the ion measurement stage 104 in a conventional manner.

In one example implementation of the particle measurement instrument 100, which should not be considered to be limiting in any way, the ion measurement stage is or includes a conventional mass spectrometer or mass analyzer. In this example implementation, the processor 24 is illustratively operable to control the voltage source VS1 to pass only ions having a first target charge to the ion trap 102, to subsequently control the voltage source VS3 to supply the collected ions into the mass spectrometer or mass analyzer and to further control the voltage source VS3 to control the mass spectrometer or mass analyzer in a conventional manner to produce mass-to-charge ratio measurements of the collected ions. Because the charge magnitudes or charge states of the collected ions are the same and are known, the processor 24 is further operable to determine the masses of the collected ions as a simple ratio of the mass-to-charge ratio measurements and the target charge value. In some embodiments, the ion trap 102 may be omitted, and the processor 24 may be operable as just described to control the voltage source VS3 to control the mass spectrometer or mass analyzer to produce mass-to-charge ratio measurements of the charge-selected ions as they exit the outlet aperture A4 of the charge filter instrument 10A. In either case, the processor 24 may be further operable in a charge scanning mode to repeat the above-described process one or more times over a selected range of target charge values. Those skilled in the art will recognize that the ion measurement stage 104 may be or include other conventional ion measurement instruments or stages configured to measure one or more molecular characteristics and/or may include one or more ion processing instruments or stages configured to process ions in any conventional manner, and it will be understood that any such implementation of the ion measurement stage 104 is intended to fall within the scope of this disclosure. Several non-limiting examples of various measurement and processing instruments that may be included in the ion measurement stage 104 will be described below with respect to FIG. 16.

Referring now to FIG. 13, an embodiment is shown of another particle measurement device 200 which includes an embodiment 10B of the charge filter instrument 10 illustrated in FIG. 1 and described above. In the embodiment illustrated in FIG. 13, the charge filter instrument 10B includes the drift region 12 having an ion inlet A1 with the charge detector array 16 including the plurality of charge detection cylinders 16₁ – 16_{N} axially arranged within the drift tube 12A between the ion inlet A1 and ion outlet A2 thereof as described above, and further includes the charge deflection or steering region 14 coupled to the outlet end of the drift tube 12A in the form of a single-inlet, multiple-outlet charge steering device. In the illustrated embodiment, the single-inlet, multiple outlet charge steering device is a single-inlet, three-outlet charge steering device having a single ion inlet A3, an oppositely-positioned ion outlet A4 and two opposing side outlets SA1, SA2, which may illustratively be implemented as either of the charge steering devices 14C, 14D illustrated in FIGS. 10A-10B and 11 respectively. Alternatively, the single-inlet, multiple-outlet charge steering device may take the form of any conventional single-inlet, multiple-outlet charged particle steering device.

The particle measurement device 200 further illustratively includes an ion storage, steering and/or measurement stage(s) 32 in the form of three separate ion storage and measurement stages 32A₁, 32A₂, 32A₃ each operatively coupled to a respective ion outlet A4, SA1, SA2 of the single-inlet, multiple-outlet charge steering device 14C, 14D. In the embodiment illustrated in FIG. 13, each stage 32A₁, 32A₂, 32A₃ is identical to the stage 32A illustrated in FIG. 12 and described above. For example, each stage 32A₁, 32A₂, 32A₃ includes a respective conventional ion trap 102₁, 102₂, 102₃ operatively coupled to a respective ion measurement stage 104₁, 104₂, 104₃. In some alternate embodiments, one or more of the stages 32A₁, 32A₂, 32A₃ may be configured differently than others of the stages 32A₁, 32A₂, 32A₃. In some alternate embodiments, one or more of the ion traps 102₁, 102₂, 102₃ may be omitted such that the respective ion outlet of the charge steering device 14C, D is coupled directly to the ion inlet of a respective ion measurement stage 104₁, 104₂, 104₃. The ion measurement stages stage 104₁, 104₂, 104₃ are likewise identical to the ion measurement stage 104 illustrated in FIG. 13 and described above.

The particle measurement device 200 further includes an ion source region 30 operatively coupled to the ion inlet end of the charge filter instrument 10B. The ion source region 30 is illustratively as described above with reference to FIGS. 1 and 12.

Operation of the particle measurement device 200 is similar to that of the particle measurement device 100 illustrated in FIG. 12 and described above in that ions are supplied by the ion source region 30 to the charge filter instrument 10B where the processor 24 is operable to determine particle charge values, and particle velocities in some embodiments, as the ions separate while drifting through the drift region 12. Unlike the particle measurement device 100, however, the particle measurement device 200 is not limited to passage of particles through a single outlet of a charge deflector, but instead configured to pass particles through any of the three outlets of the charge steering device 14C, D. With the single-inlet, three-outlet charge steering device 14C, D, the processor 24 is illustratively programmed to control the voltage source VS1, as described above, to pass through the outlet A4 only ions having a first target charge, to pass through the second outlet SA1 only ions having a second target charge different than the first target charge and to pass through the third outlet SA2 only ions having a third target charge different than the first and second target charges.

In one example implementation in which the charged particle measurement device 200 includes the ion traps 102₁, 102₂, 102₃, the processor 24 is illustratively programmed, e.g., via instructions stored in the memory 26, to control the voltage source VS1 to steer charged particles P having the first target charge out of the ion outlet A4 of the charge steering device 14C, D and into the ion trap 102₁, e.g., along the ion travel path 202₁ depicted in FIG. 13, and to control the voltage source VS3 to collect and store charged particles within the ion trap 102₁ having the first target charge, to control the voltage source VS1 to steer charged particles P having the second target charge out of the ion outlet SA2 of the charge steering device 14C, D and into the ion trap 102₂, e.g., along the ion travel path 202₂ depicted in FIG. 13, and to control the voltage source VS3 to collect and store charged particles within the ion trap 102₂ having the second target charge, and to control the voltage source VS1 to steer charged particles P having the third target charge out of the ion outlet SA1 of the charge steering device 14C, D and into the ion trap 102_{3,} e.g., along the ion travel path 202₃ depicted in FIG. 13, and to control the voltage source VS3 to collect and store charged particles within the ion trap 102₃ having the third target charge. The processor 24 is then operable to control the voltage source VS3 to selectively expel the collected charged particles from any or all of the ion traps 102₁, 102₂, 102₃ and into a respective one of the ion measurement stages 104₁, 104₂, 104₃ for analysis thereof. The processor 24 is further operable to collect, store and analyze the ion measurement information produced by the ion measurement stages 104₁, 104₂, 104₃, in a conventional manner. The particle measurement device 200 is thus similar in operation to the device 100 illustrated in FIG. 12 and described above, but is configured to simultaneously collect and analyze, or subsequently analyze, with three different ion measurement stages 104₁, 104₂, 104₃ ions having three different target charges. Those skilled in the art will recognize that the single-inlet, multiple-outlet charge steering device illustrated in FIG. 13 is not limited to three ion outlets and may thus be configured to include two or more than three ion outlets, and in such embodiments the particle measurement device 200 may accordingly include respectively two or more than three ion measurement stages 104₁, 104₂, 104₃ and, in embodiments which include them, two or more than three ion traps 102₁, 102₂, 102₃.

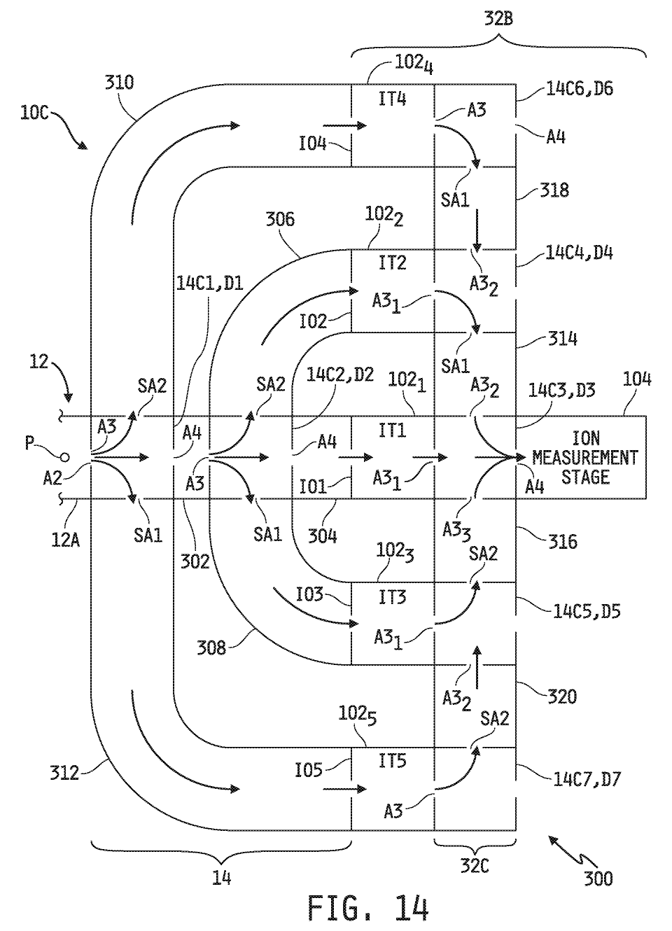

Referring now to FIG. 14, an embodiment is shown of yet another particle measurement device 300 which includes an embodiment 10C of the charge filter instrument 10 illustrated in FIG. 1 and described above. In the embodiment illustrated in FIG. 14, the charge filter instrument 10C includes the drift region 12 (partially shown in FIG. 14) having an ion inlet A1 with the charge detector array 16 including the plurality of charge detection cylinders 16₁ – 16_{N} axially arranged within the drift tube 12A between the ion inlet A1 and ion outlet A2 thereof as depicted in FIG. 1 and described above. The charge filter instrument 10C further includes the charge deflection or steering region 14 coupled to the outlet end of the drift tube 12A in the form of a charge steering region 14 including a network of two cascaded single-inlet, multiple-outlet charge steering devices and corresponding drift tubes. In the illustrated embodiment, the single-inlet, multiple outlet charge steering devices are both single-inlet, three-outlet charge steering devices each having a single ion inlet A3, an oppositely-positioned ion outlet A4 and two opposing side outlets SA1, SA2, which may illustratively be implemented as either of the charge steering devices 14C, 14D illustrated in FIGS. 10A-10B and 11 respectively. The two single-inlet, three-outlet charge steering devices forming part of the charge steering region 14 are thus illustrated in FIG. 14 as 14C1, D1 and 14C2, D2 respectively. Alternatively, the single-inlet, multiple-outlet charge steering devices may take the form of any conventional single-inlet, multiple-outlet charged particle steering devices.

In the embodiment illustrated in FIG. 14, the inlet A3 of the first charge steering device 14C1, D1 is coupled to the ion outlet A2 of the drift tube 12A, and the ion outlet A4 of the charge steering device 14C1, D1 is coupled to one end of a linear drift tube segment or section 302 having an opposite end coupled to the ion inlet A3 of the second charge steering device 14C2, D2. The ion outlet A4 of the charge steering device 14C2, D2 is coupled to one end of another linear drift tube segment or section 304 having an opposite end defining a first ion outlet IO1 of the charge steering region 14. The side ion outlet SA2 of the second charge steering device 14C2, D2 is coupled to one end of an arcuate drift tube segment or section 306 having an opposite end defining a second ion outlet IO2 of the charge steering region 14. The side ion outlet SA1 of the second charge steering device 14C2, D2 is coupled to one end of another arcuate drift tube segment or section 308 having an opposite end defining a third ion outlet IO3 of the charge steering region 14. The side ion outlet SA2 of the first charge steering device 14C1, D1 is coupled to one end of yet another arcuate drift tube segment or section 310 having an opposite end defining a fourth ion outlet IO4 of the charge steering region 14, and the side ion outlet SA1 of the first charge steering device 14C1, D1 is coupled to one end of still another arcuate drift tube segment or section 312 having an opposite end defining a fifth ion outlet IO5 of the charge steering region 14. In the illustrated embodiment, the arcuate drift tube segments or sections 306, 308, 310 and 312 are illustratively configured to steer ions along a drift path which reorients the axial direction of ion drift approximately 90 degrees. Ions exiting the side outlets SA1, SA2 of each of the charge steering devices 14C1, D1 and 14C2, D2 in directions normal to the drift direction of ions entering the inlets A3 of the charge steering devices 14C1, D1 and 14C2, D2 are thus redirected by the arcuate drift tube segments or sections 306, 308, 310, 312 such so as to exit the outlets IO1 – I05 in directions parallel with the drift direction of ions entering the inlets A3 and exiting the outlets A4 of the charge steering devices 14C1, D1 and 14C2, D2. In alternate embodiments, one or more of the drift tube segments 306, 308, 310 and 312 may be non-arcuate or may be arcuate but configured to reorient the direction of ion drift to by an acute or obtuse angle.

The particle measurement device 300 further illustratively includes an ion storage, steering and/or measurement stage(s) 32B in the form of multiple, e.g., 5, separate ion traps 102₁ – 102₅ each having an ion inlet coupled to an outlet IO1 – IO5 of a different respective one of the drift tube segments or sections 304, 306, 308,310, 312 and each having an outlet coupled via a charged particle steering network 32C to an inlet of a single ion measurement stage 104. The charged particle steering network 32C illustratively includes multiple, e.g., 5, charge steering devices operable as ion steering devices together controllable to selectively steer charged particles from each of the ion traps 102₁ – 102₅ into the inlet of the ion measurement stage 104. In the illustrated embodiment, the multiple ion steering devices are each implemented as either of the charge steering devices 14C, 14D illustrated in FIGS. 10A-10B and 11 respectively, wherein some of the multiple ion steering devices are controlled to operate as a single inlet, single outlet ion steering device, others of the multiple ion steering devices are controlled to operate as dual-inlet, single outlet ion steering devices and one of the multiple ion steering devices is controlled to operate as a three-inlet, single outlet ion steering device. For example, an ion inlet A3₁ of an ion steering device 14C3, D3 is coupled to an ion outlet of the ion trap 102₁, a ion outlet A4 opposite the ion inlet A3₁ is coupled to the ion inlet of the ion measurement stage 104, and opposite side inlets A3₂ and A3₃, adjacent to the ion inlet A3₁ and the ion outlet A4, are coupled to respective ends of two drift tube segments or sections 314 and 316 respectively. An ion inlet A3₁ of another ion steering device 14C4, D4 is coupled to an ion outlet of the ion trap 102₂, another ion inlet A3₂ adjacent to the inlet A3₁ is coupled to one end of another drift tube segment or section 318, and an ion outlet SA1 opposite the ion inlet A3₂, and adjacent to the inlet A3₁, is coupled to the opposite end of the drift tube segment or section 314. An ion inlet A3₁ of yet another ion steering device 14C5, D5 is coupled to an ion outlet of the ion trap 102₃, another ion inlet A3₂ adjacent to the inlet A3₁ is coupled to one end of yet another drift tube segment or section 320, and an ion outlet SA2 opposite the ion inlet A3₂ and adjacent to the ion inlet A3₁, is coupled to an opposite end of the drift tube segment or section 316. An ion inlet A3 of still another ion steering device 14C6, D6 is coupled to an ion outlet of the ion trap 102₄, and an ion outlet SA1 adjacent to the inlet A3 is coupled to the opposite end of the drift tube segment or section 318. An ion inlet A3 of a further ion steering device 14C7, D7 is coupled to an ion outlet of the ion trap 102₅, and an ion outlet SA2 adjacent to the inlet A3 is coupled to the opposite end of the drift tube segment or section 320.

The particle measurement device 300 is similar in operation to the device 200 illustrated in FIG. 13 and described above, but is configured to simultaneously collect ions having five different target charges, and to subsequently analyze each of the five collections with a single ion measurement stage 104. For example, ions are supplied by the ion source region 30 to the charge filter instrument 10C where the processor 24 is operable to determine particle charge values, and particle velocities in some embodiments, as the ions separate while drifting through the drift region 12 as described above. The processor 24 is illustratively programmed to control the voltage source VS1, as described above, to steer through the charge steering devices 14C1, D1 and 14C2, D2 ions having each of five different target charges. For example, ions passing from the drift tube 12A into the ion inlet A3 of the charge steering device 14C1, D1 and having a first target charge are directed by the processor 24, via control of the voltage source VS1, through the outlet A4 of the charge steering device 14C1, D1 and into the ion inlet A3 of the charge steering device 14C2, D2, and are further directed by the processor 24, via control of the voltage source VS1, through the outlet A4 of the charge steering device 14C2, D2 and into the first ion trap 102₁, and the processor 24 is further operable to control the ion trap 102₁, via control of the voltage source VS3, to collect and store such ions within the ion trap 102₁. Ions passing from the drift tube 12A into the ion inlet A3 of the charge steering device 14C1, D1 and having a second target charge are directed by the processor 24, via control of the voltage source VS1, through the outlet A4 of the charge steering device 14C1, D1 and into the ion inlet A3 of the charge steering device 14C2, D2, and are further directed by the processor 24, via control of the voltage source VS1, through the outlet SA2 of the charge steering device 14C2, D2 and into the second ion trap 102₂, and the processor 24 is further operable to control the ion trap 102₂, via control of the voltage source VS3, to collect and store such ions within the ion trap 102₂. The processor 24 is similarly operable with respect to ions passing from the drift tube 12A into the ion inlet A3 of the charge steering device 14C1, D1 and having third, fourth and fifth target charges to control the voltage source VS1 to steer such ions into the third, fourth and fifth ion traps 102₃ – 102₅ respectively, and to then control the voltage source VS3 to collect and store such ions within the ion traps 102₃ – 102₅.

The processor 24 is then operable to control the voltage source VS3 to selectively, and in some embodiments sequentially, expel the collected charged particles from the ion traps 102₁ – 102₅ and control the charged particle steering network 32C to selectively guide the charged particles into the inlet of the ion measurement stage for analysis thereof. For example, to expel the charged particles collected in the ion trap 102₁ and steer or guide the collected ions into the ion measurement stage 104, the processor 24 is operable to control the voltage source VS3 to cause the ion trap 102₁ to eject ions stored therefrom and into the ion inlet A3₁ of the ion steering device 14C3, D3, and to further control the voltage source VS3 to cause the ion steering device 14C3, D3 to pass the ions entering the ion inlet A3₁ to pass to, and through, the ion outlet A4 thereof and into the ion inlet of the ion measurement stage 104. The processor 24 is then operable to control the voltage source VS3 in a conventional manner to cause the ion measurement stage 104 to measure one or more molecular characteristics of the incoming charged particles. To expel the charged particles collected in the ion trap 102₂ and steer or guide the collected ions into the ion measurement stage 104, the processor 24 is operable to control the voltage source VS3 to cause the ion trap 102₂ to eject ions stored therefrom and into the ion inlet A3₁ of the ion steering device 14C4, D4, and to further control the voltage source VS3 to cause the ion steering device 14C4, D4 to pass the ions entering the ion inlet A3₁ to pass to, and through, the ion outlet SA1 thereof and into one end of the drift tube segment or section 314. The processor 24 is then further operable to control the voltage source VS3 to cause the charged particles passing through the drift tube segment or section 314 into the inlet A3₂ of the ion steering device 14C3, D3, and to further control the voltage source VS3 to cause the ion steering device 14C3, D3 to pass the ions entering the ion inlet A3₂ to pass to, and through, the ion outlet A4 thereof and into the ion inlet of the ion measurement stage 104. The processor 24 is then operable to control the voltage source VS3 in a conventional manner to cause the ion measurement stage 104 to measure one or more molecular characteristics of the incoming charged particles the ion inlet of the ion measurement stage 104. The processor 24 is operable to control the voltage source VS3 in like manner to eject the charged particles from the remaining ion traps 102₃ – 102₅ and to selectively guide the ejected ions into the ion inlet of the ion measurement stage 104 for analysis thereof. It will be appreciated that while the processor 24 is controlling the voltage source VS3 to eject ions from the various ion traps 102₁ – 102₅, the processor 24 may be further operable to control the voltage source VS1 to fill one or more emptied ion traps 102₁ – 102₅ with ions having a specified respective target charge. In any case, the processor 24 is further operable to collect, store and analyze all ion measurement information produced by the ion measurement stage 104 in a conventional manner.

Those skilled in the art will recognize that while the example embodiment 300 illustrated in FIG. 14 is configured to simultaneously collect ions having five different target charges, and to subsequently analyze each of the five collections with a single ion measurement stage 104, the concepts illustrated in FIG. 14 may be readily extended to devices configured to simultaneously collect more or fewer than five sets of target charges. It will be understood that any such alternate embodiments are contemplated by this disclosure. It will be further understood that while the example embodiment 300 illustrated in FIG. 14 includes five ion traps to collect ions having five respectively different charges, alternate embodiments are contemplated in which one or more, or all, of the ion traps are omitted such that ions having the respective target charge(s) may be steered by the ion steering network 32C directly into the ion measurement stage 104.

Referring now to FIG. 15, an example embodiment is shown of the ion source or source region 30 illustrated in FIGS. 1 and 12-14 and briefly described above. In the illustrated embodiment, the ion source or source region 30 illustratively includes at least one ion generator 36 coupled to the voltage source VS2 and configured to be responsive to control signals produced by the processor 24 to generate ions from a sample S. In some embodiments, the sample S is positioned within the ion source region 30, and in other embodiments the ion source S is positioned outside of the ion source region 30 as illustrated by dashed-line representation in FIG. 15. In one embodiment, the ion generator 36 is a conventional electrospray ionization (ESI) source configured to generate ions from the sample in the form of a fine mist of charged droplets. In alternate embodiments, the ion generator 36 may be or include a conventional matrix-assisted laser desorption ionization (MALDI) source. It will be understood that ESI and MALDI represent only two examples of myriad conventional ion generators, and that the ion generator 36 may be or include any such conventional device or apparatus for generating ions from a sample.

The ion source or source region 30 further illustratively includes a number R, of ion processing stage(s) IPS₁ – IPS_{R}, where R may be any positive integer. Examples of such ion processing stage(s) IPS₁ – IPS_{R} may include, but are not limited to, in any order and/or combination, one or more devices and/or instruments for separating, collecting and/or filtering charged particles according to one or more molecular characteristics, and/or one or more devices and/or instruments for dissociating, e.g., fragmenting, charged particles. In some embodiments, the ion generator 36 and/or at least one of the ion processing stages IPS₁ – IPS_{R} includes one or more conventional structures and/or devices for accelerating or otherwise propelling the generated ions through the ion inlet A1 and into the charge filter instrument 10. Examples of the one or more devices and/or instruments for separating charged particles according to one or more molecular characteristics include, but are not limited to, one or more mass spectrometers or mass analyzers, one or more ion mobility spectrometers, one or more instruments for separating charged particles based on magnetic moment, one or more instruments for separating charged particles based on dipole moment, and the like. Examples of the mass spectrometer or mass analyzer, in embodiments of the ion source 30 which include one or more thereof, include, but are not limited to, a time-of-flight (TOF) mass spectrometer, a reflectron mass spectrometer, a Fourier transform ion cyclotron resonance (FTICR) mass spectrometer, a quadrupole mass spectrometer, a triple quadrupole mass spectrometer, a magnetic sector mass spectrometer, an orbitrap, or the like. Examples of the ion mobility spectrometer, in embodiments of the ion source 30 which include one or more thereof, include, but are not limited to, a single-tube linear ion mobility spectrometer, a multiple-tube linear ion mobility spectrometer, a circular-tube ion mobility spectrometer, or the like. Examples of one or more devices and/or instruments for collecting charged particles include, but are not limited to, a quadrupole ion trap, a hexapole ion trap, or the like. Examples of one or more devices and/or instruments for filtering charged particles include, but are not limited to, one or more devices or instruments for filtering charged particles according to mass-to-charge ratio, one or more devices or instruments for filtering charged particles according to particle mobility, and the like. Examples of one or more devices and/or instruments for dissociating charged particles include, but are not limited to, one or more devices or instruments for dissociating charge particles by collision-induced dissociation (CID), surface-induced dissociation (SID), electron capture dissociation (ECD) and/or photo-induced dissociation (PID), multiphoton dissociation (MPD), or the like.

It will be understood that the ion processing stage(s) IPS₁ - IPS_{R} may include one or any combination, in any order, of any such conventional ion separation instruments and/or ion processing instruments, and that some embodiments may include multiple adjacent or spaced-apart ones of any such conventional ion separation instruments and/or ion processing instruments. As one non-limiting example, the ion processing stage(s) IPS₁ - IPS_{R} include a charged particle filtering device or instrument following the ion generator, and a dissociation device, instrument or stage following the charged particle filtering device or instrument. In this example, the processor 24 is illustratively programmed to control the voltage source VS2 to cause the charged particle filtering device or instrument to pass only ions above or below a threshold mass-to-charge ratio or within a specified range of mass-to-charge ratios, and to further control the voltage source VS2 to cause the dissociation device, instrument or stage to dissociate, e.g., fragment, the charged particles exiting the charged particle filtering device or instrument such that the dissociated charged particles exiting the dissociation device, instrument or stage enter the inlet A1 of the charge filter instrument 10. In some embodiments, a second charged particle filtering device or instrument may be disposed between the dissociation device, instrument or stage and the inlet A1 of the charge filter instrument 10, and the processor 24 may be operable in such embodiments to control the voltage source VS2 to cause the second charged particle filtering device or instrument to pass to the inlet A1 of the charge filter instrument 10 only dissociated ions above or below a threshold mass-to-charge ratio or within a specified range of mass-to-charge ratios. Other implementations of the one or more ion processing stage(s) IPS₁ – IPS_{R} within the ion source or source region 30 will occur to those skilled in the art, and it will be understood that all such other implementations are intended to fall within the scope of this disclosure.

Referring now to FIG. 16, an example embodiment is shown of the ion measurement stage 104 illustrated in FIGS. 1 and 12-14 and briefly described above. In the illustrated embodiment, the ion measurement stage 104 illustratively includes one or more ion measurement instruments IMI₁ – IMI_{S}, where S may be any positive integer. In some embodiments, the processor 24 is illustratively programmed to control each of the one or more ion measurement instruments IMI₁ – IMI_{S}, e.g., via control of the voltage source VS3, in a conventional manner to cause the ion measurement instrument(s) to measure one or more molecular characteristics of charged particles contained therein and/or passing therethrough, and/or to measure and produce information from which one or more molecular characteristics of charged particles contained therein and/or passing therethrough. In any case, ion measurement information produced by the one or more ion measurement instruments IMI₁ – IMI_{S} is illustratively processed by the processor 24 to produce, store and, in some embodiments, display the processed molecular characteristic information. In other embodiments, charge selected ions could be deposited on a suitable surface or in a matrix for collection and analysis by other methods.

Examples of such ion measurement instruments IMI₁ – IMI_{S} may include, but are not limited to, in any order and/or combination, one or more devices and/or instruments for separating charged particles in time according to one or more molecular characteristics, one or more devices and/or instruments for filtering charged particles according to one or more molecular characteristics, one or more instruments for separating charged particles based on magnetic moment, one or more instruments for separating charged particles based on dipole moment, and the like. Examples of the one or more devices and/or instruments for separating charged particles in time according to one or more molecular characteristics include, but are not limited to, one or more mass spectrometers, one or more ion mobility spectrometers, and the like. Examples of the one or more mass spectrometers, in embodiments of the ion measurement stage 104 which include one or more thereof, include, but are not limited to, a time-of-flight (TOF) mass spectrometer, a reflectron mass spectrometer, a Fourier transform ion cyclotron resonance (FTICR) mass spectrometer, a quadrupole mass spectrometer, a triple quadrupole mass spectrometer, a magnetic sector mass spectrometer, an orbitrap, or the like. Examples of the one or more ion mobility spectrometers, in embodiments of the ion measurement stage 104 which include one or more thereof, include, but are not limited to, a single-tube linear ion mobility spectrometer, a multiple-tube linear ion mobility spectrometer, a circular-tube ion mobility spectrometer, or the like. Examples of one or more devices and/or instruments for filtering charged particles include, but are not limited to, one or more devices or instruments for filtering charged particles according to mass-to-charge ratio, one or more devices or instruments for filtering charged particles according to particle mobility, magnetic moment, dipole moment, and the like. Examples of the one or more devices or instruments for filtering charged particles according to mass-to-charge ratio, in embodiments of the ion measurement stage 104 which include one or more thereof, include, but are not limited to, a quadrupole mass analyzer or quadrupole mass filter, a quadrupole ion trap mass analyzer or mass filter, a magnetic sector mass analyzer, a time-of-flight mass analyzer, a reflectron mass analyzer, a Fourier transform ion cyclotron resonance (FTICR) mass analyzer, an orbitrap, or the like. Examples of the one or more devices or instruments for filtering charged particles according to particle mobility, in embodiments of the ion measurement stage 104 which include one or more thereof, include, but are not limited to, a single-tube linear ion mobility spectrometer, a multiple-tube linear ion mobility spectrometer, a circular-tube ion mobility spectrometer, or the like. It will be understood that the ion measurement stage 104 may include one or any combination, in any order, of any such instruments for separating charged particles in time according to one or more molecular characteristics and/or one or more devices or instruments for filtering charged particles according to one or more molecular characteristics, and the like, and that some embodiments may include multiple adjacent or spaced-apart ones of any such instruments or devices.

Referring now to FIG. 17, an embodiment is shown of still another particle measurement device 400 which includes two spaced-apart charge filter instruments 10₁, 10₂ separated by an ion processing region 402. In the illustrated embodiment, an ion source region 30, as described above, is coupled to an inlet end of a first charge filter instrument 10₁, and the ion outlet end of the charge deflection or steering region 14 of the first charge filter instrument 10₁ is coupled to an inlet of the ion processing region 402, an ion outlet of the ion processing region 402 is coupled to the inlet end of the second charge filter instrument 10₂, and the ion outlet end of the charge deflection or steering region 14 of the second charge filter instrument 10₂ is coupled to an inlet of an ion storage, steering and/or measurement stage(s) 32, also as described above. Each of the charge filter instruments 10₁, 10₂ includes a drift region 12 having an ion inlet A1 with the charge detector array 16 including the plurality of charge detection cylinders 16₁ – 16_{N} axially arranged within the drift tube 12A between the ion inlet A1 and ion outlet A2 thereof as depicted in FIG. 1 and described above, and further includes the charge deflection or steering region 14, in any of the forms illustrated and/or described herein, coupled to the outlet end of the drift tube 12A.

The ion processing region 402 of the particle measurement device 400 illustratively includes one or more ion processing stages IS₁ – IS_{T}, where T may be any positive integer. The one or more of the ion processing stages IS₁ – IS_{T} may illustratively include, for example, but is not limited to, one or more conventional instruments for separating ions according to one or more molecular characteristics (e.g., according to ion mass-to-charge ratio, ion mobility, magnetic moment, dipole moment, or the like) and/or one or more conventional ion processing instruments for collecting and/or storing ions (e.g., one or more quadrupole, hexapole and/or other ion traps), one or more conventional instruments or devices for filtering ions (e.g., according to one or more molecular characteristics such as ion mass-to-charge ratio, ion mobility, magnetic moment, dipole moment, and the like), one or more instruments, devices or stages for fragmenting or otherwise dissociating ions, and the like. It will be understood that the ion processing stage 402 may include one or any combination, in any order, of any such instruments, devices or stages, and that some embodiments may include multiple adjacent or spaced-apart ones of any such instruments, devices or stages. It will be further understood that any of the example combinations of instruments, devices or stages described above may be implemented as, or as part of, the ion processing stage 402. Those skilled in the art will recognize other instruments, devices and/or stages that may be included in the ion processing stage 402, whether or not illustrated and/or described herein, as well as other combinations of instruments, devices or stages that may be implemented as, or as part of, the ion processing stage 402, and it will be understood that all such other instruments, devices and/or stages, as well as any combination of any instruments, devices and/or stages, are intended to fall within the scope of this disclosure.

It will be appreciated that because the charge magnitude and/or charge state of any individual charged particle, or of any collection, set or group of charged particles, passed to the ion measurement stage 104 of any of the particle measurement instruments 100, 200, 300, 400 described herein will be known, i.e., as a result of the control and operation of the charge filter instrument 10 as described above, molecular characteristic information not heretofore obtainable from conventional ion measurement instruments may now be easily determined. As one non-limiting example, particle mass-to-charge ratio values obtainable from conventional mass spectrometers and mass analyzers may be easily converted to particle mass values using the known charge magnitude or charge state information. As another non-limiting example, particle mobility values obtainable from conventional ion mobility spectrometers may be easily converted to particle collision cross-sectional area values using the known charge magnitude or charge state information. As a further non-limiting example, with the charge magnitude or charge state of collections, groups or sets of charged particles known, conventional mass-to-charge ratio filters may be operated as true mass filters to select for passage particles having a specified mass or range of masses. Other examples will occur to those skilled in the art, and any such other examples are intended to fall within the scope of this disclosure.

While this disclosure has been illustrated and described in detail in the foregoing drawings and description, the same is to be considered as illustrative and not restrictive in character, it being understood that only illustrative embodiments thereof have been shown and described and that all changes and modifications that come within the spirit of this disclosure are desired to be protected. For example, while several structures are illustrated in the attached figures and are described herein as being controllable and/or configurable to establish one or more electric fields therein configured and oriented to accelerate and/or steer and/or otherwise operate on charged particles, those skilled in the art will recognize that acceleration and/or steering of and/or other operation on charged particles may, in some cases, be alternatively or additionally accomplished via one or more magnetic fields. It will be accordingly understood that any conventional structures and/or mechanisms for substituting or enhancing one or more of the electric fields described herein with one or more suitable magnetic fields are intended to fall within the scope of this disclosure.

What is claimed is:

1. A charge filter instrument, comprising:
an electric field-free drift region having an inlet end and an outlet end opposite the inlet end, the inlet end configured to be coupled to an ion source to receive a plurality of ions to drift axially through the drift region and separate from one another as a function mass-to-charge ratio as the plurality of ions drift from the inlet end toward the outlet end, the plurality of ions including ions having charge states or charge magnitudes different from others of the plurality of ions,
a plurality of spaced-apart charge detection cylinders disposed in the drift region and through which the plurality of ions drifting axially through the drift region pass,
a plurality of charge sensitive amplifiers each coupled to at least one of the plurality of charge detection cylinders and each configured to produce a charge detection signal corresponding to a magnitude of charge induced thereon by a single ion passing therethrough or by a magnitude of charge induced thereon by a combination of multiple ions simultaneously passing therethrough,
one of a charge deflector having a single inlet coupled to the outlet end of the drift region and a single outlet, and a charge steering device having a single inlet coupled to the outlet end of the drift region and multiple outlets,
at least one processor, and
at least one memory having instructions stored therein and executable by the at least one processor to cause the at least one processor to
(a) monitor the charge detection signals produced by at least some of the plurality of charge sensitive amplifiers as the plurality of ions drift axially through the field-free drift region toward the outlet end thereof,
(b) determine charge magnitudes or charge states of each of the plurality of ions drifting axially through the field-free drift region based on the monitored charge detection signals, and
(c) for each of the plurality of ions exiting the outlet end of the drift region, control the one of the charge deflector and the charge steering device so as to pass through a corresponding one of the single outlet and a specified one of the multiple outlets only ions having a determined charge magnitude or charge state equal to, or within a specified range of, a specified charge magnitude or charge state.

2. The charge filter instrument of claim 1, wherein the one of the charge deflector and the charge steering device comprises the charge deflector,
and further comprising at least one ion measurement instrument having an inlet coupled to the single outlet of the charge deflector, the at least one ion measurement instrument configured to measure at least one molecular characteristic of ions exiting the single outlet of the charge deflector.

3. The charge filter instrument of claim 2, further comprising:
an ion trap disposed between the single outlet of the charge deflector and the inlet of the at least one ion measurement instrument, the ion trap configured to trap therein ions exiting the single outlet of the charge deflector, and
means for controlling the ion trap to selectively release ions trapped therein into the ion inlet of the at least one ion measurement instrument.

4. The charge filter instrument of claim 1, further comprising the ion source, the ion source including an ion generator configured to generate ions from a sample and to supply the generated ions to the inlet of the drift region such that the generated plurality of ions drift axially through the drift region toward the ion outlet end thereof.

5. The charge filter instrument of claim 4, wherein the ion source further includes at least one of (i) at least one instrument for separating the generated plurality of ions according to at least one molecular characteristic, (ii) at least one dissociation stage configured to dissociate the generated plurality of ions passing therethrough, and (iii) at least one ion trap configured to trap the plurality of ions therein and to selectively release trapped ions therefrom.

6. The charge filter instrument of claim 1, wherein the one of the charge deflector and the charge steering device comprises the charge steering device,
and wherein the means for controlling the charge steering device comprises means for controlling the charge steering device to pass through a first one of the multiple outlets only ions having a first specified charge magnitude or charge state and to pass through a second one of the multiple outlets only ions having a second specified charge magnitude or charge state different from the first specified charge magnitude or charge state.

7. The charge filter instrument of claim 6, further comprising:
at least a first ion measurement instrument having an inlet coupled to the first one of the multiple outlets of the charge steering device, the at least a first ion measurement instrument configured to measure at least one molecular characteristic of ions exiting the first one of the multiple outlets of the charge steering device, and
at least a second ion measurement instrument having an inlet coupled to the second one of the multiple outlets of the charge steering device, the at least a second ion measurement instrument configured to measure at least one molecular characteristic of ions exiting the second one of the multiple outlets of the charge steering device.

8. The charge filter instrument of claim 7, further comprising:
a first ion trap disposed between the first one of the multiple outlets of the charge steering device and the inlet of the first ion measurement instrument, the first ion trap configured to trap therein ions exiting the first one of the multiple outlets of the charge steering device,
a second ion trap disposed between the second one of the multiple outlets of the charge steering device and the inlet of the second ion measurement instrument, the second ion trap configured to trap therein ions exiting the second one of the multiple outlets of the charge steering device,
means for controlling the first ion trap to selectively release ions trapped therein into the ion inlet of the first ion measurement instrument, and
means for controlling the second ion trap to selectively release ions trapped therein into the ion inlet of the second ion measurement instrument.

9. The charge filter instrument of claim 7, further comprising:
a first ion trap having an inlet coupled to the first one of the multiple outlets of the charge steering device and an outlet, the first ion trap configured to trap therein ions exiting the first one of the multiple outlets of the charge steering device,
a second ion trap having an inlet coupled to the second one of the multiple outlets of the charge steering device and an outlet, the second ion trap configured to trap therein ions exiting the second one of the multiple outlets of the charge steering device,
at least one ion measurement instrument having an inlet and configured to measure at least one molecular characteristic of ions entering the inlet thereof,
an ion steering network having a first inlet coupled to the outlet of the first ion trap, a second inlet coupled to the outlet of the second ion trap and an outlet coupled to the inlet of the at least one ion measurement instrument, and
means for controlling (i) the first ion trap to selectively release ions trapped therein into the first ion inlet of the ion steering network and the ion steering network to selectively pass ions exiting the outlet of the first ion trap into the inlet of the at least one ion measurement instrument, and (ii) the second ion trap to selectively release ions trapped therein into the second ion inlet of the ion steering network and the ion steering network to selectively pass ions exiting the outlet of the second ion trap into the inlet of the at least one ion measurement instrument.

10. The charge filter instrument of claim 1, wherein the electric field-free drift region is a first electric field-free drift region, the plurality of charge detection cylinders is a first plurality of charge detection cylinders, the plurality of charge sensitive amplifiers is a first plurality of charge sensitive amplifiers, the one of a charge deflector and a charge steering device is one of a first charge deflector and a first charge steering device, the means for determining charge magnitudes or charge states is a first means for determining charge magnitudes or charge states, the means for controlling is a first means for controlling,
and wherein the ion filter instrument comprising the first electric field-free drift region, the first plurality of charge detection cylinders, the first plurality of charge sensitive amplifiers, the one of the first charge deflector and the first charge steering device, the first means for determining charge magnitudes or charge states and the first means for controlling is a first charge filter instrument,
and further comprising:
a second ion filter instrument identical to the first charge filter instrument, the second charge filter instrument comprising a second electric field-free drift region having a second inlet end and a second outlet end opposite the second inlet end, and a second plurality of charge detection cylinders disposed in the second electric field-free drift region and
at least one ion processing stage disposed between the one of the single outlet and the specified one of the multiple outlets of the corresponding one of the first charge deflector and the first charge steering device and the second inlet end of the second electric field-free drift region of the second charge filter instrument.

11. The charge filter instrument of claim 10, wherein the at least one ion processing stage comprises at least one of (i) at least one instrument for separating ions in time according to at least one molecular characteristic, (ii) at least one ion filter configured to pass therethrough only ions having a specified molecular characteristic or having a molecular characteristic within a specified range of molecular characteristics, (iii) at least one ion trap configured to selectively trap ions therein and to selectively release ions therefrom, and (iv) at least one dissociation stage configured to dissociate ions passing therethrough.

12. The charge filter instrument of claim 10, further comprising the ion source, the ion source including an ion generator configured to generate ions from a sample and to supply the generated ions to the inlet of the drift region such that the generated plurality of ions drift axially through the drift region toward the ion outlet end thereof.

13. The charge filter instrument of claim 12, wherein the ion source further includes at least one of (i) at least one instrument for separating the generated plurality of ions according to at least one molecular characteristic, (ii) at least one dissociation stage configured to dissociate the generated plurality of ions passing therethrough, and (iii) at least one ion trap configured to trap the plurality of ions therein and to selectively release trapped ions therefrom.

14. The charge filter instrument of claim 1, wherein the instructions stored in the at least one memory further include instructions executable by the at least one processor to cause the at least one processor to
monitor the charge detection signals produced by the plurality of charge sensitive amplifiers by monitoring edge events of the monitored charge detection signals defined by rising and falling edges thereof, and by monitoring signal magnitudes between adjacent edge events of the monitored charge detection signals, and
determine charge magnitudes or charge states of each of the ions drifting axially through the field-free drift region by
(i) processing the edge events of the charge detection signal produced by each successive one of the plurality of charge sensitive amplifiers to identify entrance of the ion into and exit of the ion from each respective one of the charge detection cylinders,
(ii) between each successive entry and exit of the ion into and from a respective one of the charge detection cylinders, processing the signal magnitude of the charge detection signal produced by the respective one of the charge sensitive amplifiers to determine the charge magnitude or charge state of the ion, and
(iii) updating the determination of the charge magnitude or charge state of the ion with each successive determination of the charge magnitude or charge state of the ion based on the respective one of the charge detection signals.

15. A charge filter instrument, comprising:
an electric field-free drift region having an inlet end and an outlet end opposite the inlet end, the inlet end configured to be coupled to an ion source to receive a plurality of ions to drift axially through the drift region and separate from one another as a function mass-to-charge ratio as the plurality of ions drift from the inlet end toward the outlet end, the plurality of ions including ions having charge states or charge magnitudes different from others of the plurality of ions,
a plurality of spaced-apart charge detection cylinders disposed in the drift region and through which the plurality of ions drifting axially through the drift region pass,
a plurality of charge sensitive amplifiers each coupled to at least one of the plurality of charge detection cylinders and each configured to produce a charge detection signal corresponding to a magnitude of charge induced thereon by a single ion passing therethrough or by a combination of multiple ions simultaneously passing therethrough,
one of a charge deflector having a single inlet coupled to the outlet end of the drift region and a single outlet, and a charge steering device having a single inlet coupled to the outlet end of the drift region and multiple outlets,
at least one processor, and
at least one memory having instructions stored therein and executable by the at least one processor to cause the at least one processor to
(a) determine edge events and signal magnitudes of the charge detection signals, the edge events defined by rising and falling edges of each of the charge detection signals and the signal magnitudes defined between respective edge events of each charge detection signal,
(b) for each of the plurality of ions drifting axially through the field-free drift region, (i) process the edge events of the charge detection signal produced by each successive one of the plurality of charge sensitive amplifiers to identify entrance of the ion into and exit of the ion from a respective one of the charge detection cylinders, (ii) between each successive entry and exit of the ion into and from a respective one of the charge detection cylinders, process the signal magnitude of the respective charge detection signal to determine the charge magnitude or charge state of the ion, and (iii) update the determination of the charge magnitude or charge state of the ion with each successive determination of the charge magnitude or charge state of the ion based on the respective one of the charge detection signals, and
(c) for each of the plurality of ions exiting the outlet end of the drift region, control the one of the charge deflector and the charge steering device so as to pass through a corresponding one of the single outlet and a specified one of the multiple outlets only ions having a determined charge magnitude or charge state equal to, or within a specified range of, a specified charge magnitude or charge state.

16. The charge filter instrument of claim 15, further comprising the ion source, the ion source including an ion generator configured to generate ions from a sample and to supply the generated ions to the inlet of the drift region such that the generated plurality of ions drift axially through the drift region toward the ion outlet end thereof.

17. The charge filter instrument of claim 16, wherein the ion source further includes at least one of (i) at least one instrument for separating the generated plurality of ions according to at least one molecular characteristic, (ii) at least one dissociation stage configured to dissociate the generated plurality of ions passing therethrough, and (iii) at least one ion trap configured to trap the plurality of ions therein and to selectively release trapped ions therefrom.

18. The charge filter instrument of claim 15, wherein the one of the charge deflector and the charge steering device comprises the charge deflector,
and further comprising at least one ion measurement instrument having an inlet coupled to the single outlet of the charge deflector, the at least one ion measurement instrument configured to measure at least one molecular characteristic of ions exiting the single outlet of the charge deflector.

19. The charge filter instrument of claim 15, wherein the one of the charge deflector and the charge steering device comprises the charge steering device,
and wherein the means for controlling the charge steering device comprises means for controlling the charge steering device to pass through a first one of the multiple outlets only ions having a first specified charge magnitude or charge state and to pass through a second one of the multiple outlets only ions having a second specified charge magnitude or charge state different from the first specified charge magnitude or charge state,
and further comprising at least a first ion measurement instrument having an inlet coupled to the first one of the multiple outlets of the charge steering device, the at least a first ion measurement instrument configured to measure at least one molecular characteristic of ions exiting the first one of the multiple outlets of the charge steering device, and
at least a second ion measurement instrument having an inlet coupled to the second one of the multiple outlets of the charge steering device, the at least a second ion measurement instrument configured to measure at least one molecular characteristic of ions exiting the second one of the multiple outlets of the charge steering device.

20. The charge filter instrument of claim 19, further comprising:
a first ion trap disposed between the first one of the multiple outlets of the charge steering device and the inlet of the first ion measurement instrument, the first ion trap configured to trap therein ions exiting the first one of the multiple outlets of the charge steering device,
a second ion trap disposed between the second one of the multiple outlets of the charge steering device and the inlet of the second ion measurement instrument, the second ion trap configured to trap therein ions exiting the second one of the multiple outlets of the charge steering device,
means for controlling the first ion trap to selectively release ions trapped therein into the ion inlet of the first ion measurement instrument, and
means for controlling the second ion trap to selectively release ions trapped therein into the ion inlet of the second ion measurement instrument.
